(19) United States
(12) Patent Application Publication
(10) Pub. No.: US 2026/0332699 A1
(43) Pub. Date: Oct. 22, 2026

(54) SYSTEM AND METHOD FOR DEVICE-BASED VERIFICATION OF CALLER IDENTITY USING A SEPARATE VERIFICATION DATA CHANNEL

(71) Applicant: Aarush Sharma, Pleasanton, CA (US)

(72) Inventor: Aarush Sharma, Pleasanton, CA (US)

(21) Appl. No.: 19/693,433

(22) Filed: May 30, 2026

Related U.S. Application Data
(60) Provisional application No. 64/042,158, filed on Apr. 17, 2026.

(51) Int. Cl. H04M 3/42; H04L 9/08; H04L 9/30; H04L 9/32; H04M 3/38

(52) U.S. Cl. CPC H04M 3/42042; H04L 9/0825; H04L 9/0852; H04L 9/30; H04L 9/3252; H04L 9/3271; H04M 3/382; H04M 3/42093

(57) ABSTRACT

A system and method verify an identity associated with a voice call. A caller computing device generates a per-call challenge associated with a particular instance of the voice call and produces a digital signature over the per-call challenge using a device-bound private signing key associated with the caller computing device. The caller computing device initiates a voice call to a recipient computing device over a voice transport channel and transmits a verification payload to the recipient computing device over a verification data channel separate from the voice transport channel. The verification payload includes the per-call challenge and the digital signature. The recipient computing device obtains a public verification key associated with the identity of a caller and verifies the digital signature using the public verification key to generate a verification result locally at the recipient computing device.

This application claims the benefit of priority to U.S. Provisional Patent

Application No. 64/042,158, filed Apr. 17, 2026, the disclosure of which is incorporated herein by reference in its entirety for all subject matter disclosed therein. Additional subject matter presented in this application, if any, is entitled to the filing date of this application.

### TECHNICAL FIELD

The invention relates generally to telecommunications security and identity verification. More particularly, the invention relates to systems and methods for verifying an identity associated with a voice call by using a device bound private signing key to produce a digital signature over a per call challenge, transmitting a verification payload over a verification data channel separate from a voice transport channel, and locally verifying the digital signature at a recipient computing device before the voice call is answered.

### BACKGROUND

Voice calls remain one of the most widely used forms of real time communication for personal, commercial, financial, medical, legal, and governmental interactions. A recipient of a voice call often relies on information displayed by a receiving device, such as a telephone number, contact name, caller identification field, or enterprise name, to decide whether to answer the voice call and whether to trust the person speaking during the voice call. Conventional caller identification systems, however, generally depend on signaling information supplied by a carrier network, voice service provider, calling platform, or intermediate call routing system. Such signalling information does not necessarily prove that the displayed caller identity corresponds to the actual person or device that initiated the voice call.

Caller identification spoofing creates a significant weakness in conventional voice communication systems. A malicious actor may cause a recipient device to display a telephone number or caller name associated with another person, business, financial institution, or trusted contact. The malicious actor may use voice over internet protocol services, compromised accounts, private branch exchange systems, call forwarding systems, or other call origination systems to place a voice call that appears to originate from a trusted identity. As a result, the recipient may answer the voice call and disclose sensitive information, approve a transaction, transfer funds, reveal credentials, or otherwise act in reliance on a false caller identity.

Artificial intelligence-based voice synthesis and voice cloning further increase this risk. A malicious actor may use a synthetic voice that resembles the voice of a family member, executive, customer, patient, attorney, banker, or other trusted person. In such a scenario, the recipient may not be able to distinguish the malicious actor from the trusted person based only on the audio content of the voice call. Traditional human recognition of a caller by voice therefore no longer provides a reliable safeguard against impersonation.

Some existing approaches attempt to address caller identity fraud at the network level. For example, certain carrier-based frameworks authenticate whether a calling party has authority to use a telephone number or whether a carrier has attested to the call origination. These approaches may improve trust in number assignment or network routing information. However, such approaches generally do not prove that a particular physical device, user device, or end user personally initiated the voice call. A network level attestation may still fail to protect against compromised accounts, unauthorized account access, number porting attacks, subscriber identity module swap attacks, insider misuse, or scenarios in which a malicious actor gains control of a legitimate telephone number or calling account.

Other existing approaches use call screening, spam scoring, reputation databases, or analytics based fraud detection. These approaches may evaluate calling patterns, historical complaints, call frequency, originating network characteristics, or other risk indicators. Such approaches may reduce unwanted calls in some circumstances, but they do not provide a cryptographic proof of caller identity. A previously unknown malicious actor, a targeted attacker, or an attacker using a newly compromised number may evade reputation based systems. Conversely, legitimate calls may receive inaccurate risk scores. These approaches therefore do not give a recipient a direct cryptographic basis to trust the identity displayed for a particular voice call.

Some communication applications provide encrypted calling between users of the same application. Such applications may authenticate application accounts and may protect call content within the application environment. However, these systems often require both parties to place and receive the voice call through the same proprietary application or platform. They may not verify a standard cellular, public switched telephone network, satellite, enterprise telephony, or native operating system voice call that arrives through a separate voice transport channel. In many situations, users continue to place and receive ordinary voice calls using native dialers and existing telephone numbers. A verification mechanism limited to a proprietary calling platform may therefore fail to protect a recipient during ordinary voice calls.

Other approaches use multi factor authentication during or after a voice call. For example, a caller may receive a one time passcode, approve a push notification, answer a knowledge-based question, or provide a biometric input during a customer service interaction. These approaches may help authenticate a caller after a call has begun. However, they often require active user participation, depend on a server or call center to determine the authentication result, occur only after the recipient has already answered the voice call, or authenticate access to an account rather than the identity associated with the incoming voice call itself. These approaches may not provide an automatic indication to the recipient before the recipient decides whether to answer the voice call.

Some proposed systems transmit verification information over a separate data path while a voice call occurs over a telephone network. Such systems may send a message, token, or confirmation request to a device associated with a telephone number. However, these systems may rely on a server to generate or determine a verification result, may authenticate possession of an account or number rather than possession of a device bound private signing key, may not use a per call challenge tied to a particular call instance, or may not cause the recipient computing device to locally verify a digital signature before the voice call is answered. In such systems, compromise of a server or account may affect the trustworthiness of the verification result.

Further, public key cryptography has also been used in communication systems to authenticate messages, sessions, users, or devices. In many implementations, however, a private key may reside in software storage, may be exportable, may be controlled by a server, or may not be specifically bound to a particular caller computing device. If an attacker obtains the private key or compromises a server that controls the private key, the attacker may impersonate the associated identity. Furthermore, many existing public key systems use classical algorithms that may not provide long term protection against future cryptographic threats.

There are several solutions proposed in the prior art. One close prior art example includes U.S. Pat. No. 10,122,851B2 , entitled “Out-of-band call verification,” which relates to verifying a telephone call by receiving a verification request over a data network for a communication placed over a telephone network and sending a verification message to a called device over the data network. This reference uses a data network that is logically separate from a telephone network to provide call verification information. However, this system does not disclose a caller computing device producing a digital signature over a per call challenge using a device bound private signing key, and it does not disclose a recipient computing device locally verifying the digital signature using a public verification key associated with an identity of a caller before the voice call is answered.

Another close prior art example includes U.S. Pat. No. 11,824,994B2 , entitled “Validating and securing caller identification to prevent identity spoofing,” which relates to adding a cryptographic signature to call information and using a call security platform to verify caller identification and add authentication information to the call information. This reference uses cryptographic information in connection with caller identification and call routing. However, this system does not disclose a verification data channel separate from a voice transport channel that carries a verification payload from a caller computing device to a recipient computing device, and it does not disclose the recipient computing device generating a verification result locally without a server determining the verification result. This system also does not disclose displaying, by the recipient computing device, an indication of the verification result before the voice call is answered.

Accordingly, a need remains for a caller identity verification system that can operate with existing voice calling infrastructure while providing a cryptographic proof associated with a particular call instance. A further need exists for a system in which a caller computing device produces a digital signature over a per call challenge using a device bound private signing key, a recipient computing device receives a verification payload over a verification data channel separate from a voice transport channel, and the recipient computing device locally verifies the digital signature using a public verification key associated with an identity of the caller.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

The invention provides systems, methods, and non-transitory computer-readable media for verifying an identity associated with a voice call. In one embodiment, a caller computing device generates a per call challenge associated with a particular instance of the voice call. The caller computing device produces a digital signature over the per call challenge using a device bound private signing key associated with the caller computing device. The caller computing device initiates the voice call to a recipient computing device over a voice transport channel and transmits a verification payload to the recipient computing device over a verification data channel that is separate from the voice transport channel. The verification payload includes the per call challenge and the digital signature.

The recipient computing device obtains a public verification key associated with an identity of a caller of the voice call. The recipient computing device verifies the digital signature using the public verification key and generates a verification result locally at the recipient computing device. In some embodiments, the recipient computing device generates the verification result without receiving the verification result from a server. The recipient computing device displays an indication of the verification result before the voice call is answered at the recipient computing device.

In some embodiments, the device bound private signing key resides in, remains protected by, or otherwise operates with a hardware backed secure storage component of the caller computing device. The hardware backed secure storage component may include a secure enclave, a hardware security module, a trusted execution environment, a hardware backed keystore, a secure element, a trusted platform module, or another secure storage component that prevents export of plaintext private key material.

In some embodiments, the caller computing device produces the digital signature using an asymmetric digital signature algorithm. The asymmetric digital signature algorithm may include a post quantum digital signature algorithm, a classical public key digital signature algorithm, or a hybrid signature scheme that includes both a post quantum digital signature and a classical public key digital signature. In particular embodiments, the asymmetric digital signature algorithm includes ML-DSA, SLH-DSA, Falcon, ECDSA, EdDSA, RSA-PSS, or another suitable signature algorithm.

In some embodiments, the per call challenge includes a call identifier, a timestamp, and a nonce. The recipient computing device may reject the verification payload when the timestamp falls outside a predetermined recency window. The use of the call identifier, the timestamp, and the nonce helps associate the per call challenge with the particular instance of the voice call and helps reduce replay of a previously captured verification payload.

In some embodiments, the voice transport channel includes a cellular voice channel, a public switched telephone network channel, a Voice over Internet Protocol channel, a satellite voice channel, a native telephony channel of a mobile operating system, or another voice communication channel. The verification data channel may include a push-notification channel, a messaging channel, a packet data channel, a signaling channel, a WebRTC data channel, a SIP signaling channel, an RCS channel, a carrier signaling channel, or another data communication channel separate from the voice transport channel.

In some embodiments, the caller computing device initiates the voice call by invoking a native telephony function of an operating system of the caller computing device. In such embodiments, infrastructure that routes the verification payload need not carry audio content of the voice call. This configuration allows the voice call and the verification payload to travel through separate communication paths while the recipient computing device performs identity verification before the recipient answers the voice call.

In some embodiments, the caller computing device requires successful local user authentication before producing the digital signature. The local user authentication may include biometric authentication, passcode authentication, device unlock authentication, possession of the caller computing device, or a combination thereof. The recipient computing device may also generate the verification result based on the digital signature and one or more additional authentication factors, including biometric authentication, device unlock status, subscriber identity module status, location consistency, device attestation, account authentication, or enterprise identity provider authentication.

In some embodiments, an identity directory server stores the public verification key associated with the identity of the caller. The identity directory server may associate the public verification key with an identity anchor, including a telephone number, a subscriber identity module identifier, a device identifier, an operating system identity, an enterprise identity, a decentralized identifier, a carrier issued identity, a government issued identity, or another identity anchor. The recipient computing device may obtain the public verification key from the identity directory server or from a local cache.

In some embodiments, the recipient computing device stores the public verification key as a pinned public verification key. The recipient computing device may display a key change warning when a subsequently obtained public verification key for the identity of the caller differs from the pinned public verification key. In some embodiments, the identity directory server stores multiple public verification keys associated with the identity of the caller, and the recipient computing device generates the verification result by determining whether the digital signature verifies against at least one of the multiple public verification keys.

In some embodiments, the caller computing device rotates the device bound private signing key by generating a replacement public verification key and causing a key transition record to be stored in the identity directory server. The key transition record may include the replacement public verification key signed using the device bound private signing key. The system may also support key revocation, lost device recovery, multi device identities, and other key management operations.

In some embodiments, the recipient computing device transmits a recipient verification payload to the caller computing device. The recipient verification payload may include a recipient per call challenge, a signed response, or both. The caller computing device locally verifies the recipient verification payload and produces a mutual verification result. The caller computing device may display the mutual verification result before or during the voice call.

In some embodiments, the system supports verified business caller display. A merchant verification server may verify a business entity, validate one or more authorized calling identifiers, validate one or more brand elements, and issue or store a merchant certificate that binds business identity information, the one or more authorized calling identifiers, the one or more brand elements, and one or more merchant public verification keys to the business entity. During a voice call associated with the business entity, a recipient computing device may receive a verification payload including a per call challenge, a digital signature, and merchant certificate information. The recipient computing device may locally verify the digital signature using a merchant public verification key and may validate the merchant certificate information before displaying a verified business call indication.

In some embodiments, the verified business call indication includes a business name, logo, department name, call reason, verified merchant badge, certificate assurance indication, or combination thereof. The recipient computing device may display the verified business call indication before the voice call is answered. In some embodiments, the recipient computing device displays a verified business caller differently from a verified individual caller so that a recipient can distinguish between an individual device verified identity and a merchant certificate verified business identity.

These and other features and advantages of the present invention will become apparent from the detailed description below, in light of the accompanying drawings.

### BRIEF DESCRIPTION OF THE DRAWINGS

FIG. 1 illustrates a general environment for implementing a system for verifying an identity associated with a voice call, according to one or more embodiments of the present invention;

FIG. 2 illustrates an example registration process in which a caller computing device generates or obtains a device bound private signing key and causes a corresponding public verification key to be associated with an identity in an identity directory server, according to one or more embodiments of the present invention;

FIG. 3 illustrates an example call initiation process in which the caller computing device generates a per call challenge, produces a digital signature over the per call challenge, initiates a voice call over a voice transport channel, and transmits a verification payload over a verification data channel separate from the voice transport channel, according to one or more embodiments of the present invention;

FIG. 4 illustrates an example recipient verification process in which a recipient computing device receives the verification payload, obtains the public verification key, locally verifies the digital signature, and generates a verification result, according to one or more embodiments of the present invention;

FIG. 5 illustrates an example mutual verification process in which the caller computing device and the recipient computing device each verify an identity associated with the other computing device during a particular instance of the voice call, according to one or more embodiments of the present invention;

FIG. 6 illustrates an example user interface of the caller computing device displaying an indication of a verification result associated with the recipient computing device, according to one or more embodiments of the present invention;

FIG. 7 illustrates an example user interface of the recipient computing device displaying an indication that the identity of the caller is verified before the voice call is answered, according to one or more embodiments of the present invention;

FIG. 8 illustrates an example user interface of the recipient computing device displaying an indication that the identity of the caller is not verified before the voice call is answered, according to one or more embodiments of the present invention;

FIG. 9 illustrates an example secure key architecture in which a hardware backed secure storage component protects the device bound private signing key and enables the caller computing device to produce the digital signature without exporting plaintext private key material, according to one or more embodiments of the present invention;

FIG. 10 illustrates an example structure of the per call challenge including a call identifier, a timestamp, and a nonce, according to one or more embodiments of the present invention;

FIG. 11 illustrates an example implementation in which a voice session server or relay infrastructure carries or assists with a voice communication while the recipient computing device performs signature verification using the public verification key, according to one or more embodiments of the present invention;

FIG. 12 illustrates example alternative implementations, including native operating system telephony integration and carrier network integration, in which verification information is presented through a native call interface or carrier-controlled call display infrastructure, according to one or more embodiments of the present invention;

FIG. 13 illustrates an example verified merchant certificate issuance process in which a merchant registration request is received, business identity and brand elements are validated, one or more authorized calling identifiers and public verification keys are associated with the merchant, and a merchant certificate is issued or stored; and

FIG. 14 illustrates an example verified business incoming-call user interface in which a recipient computing device displays a verified business name, logo, department, call reason, verified merchant badge, and certificate assurance indication before a voice call is answered.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a system for verifying an identity associated with a voice call. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items. Further, the word “user” and “person” are used interchangeably in the description.

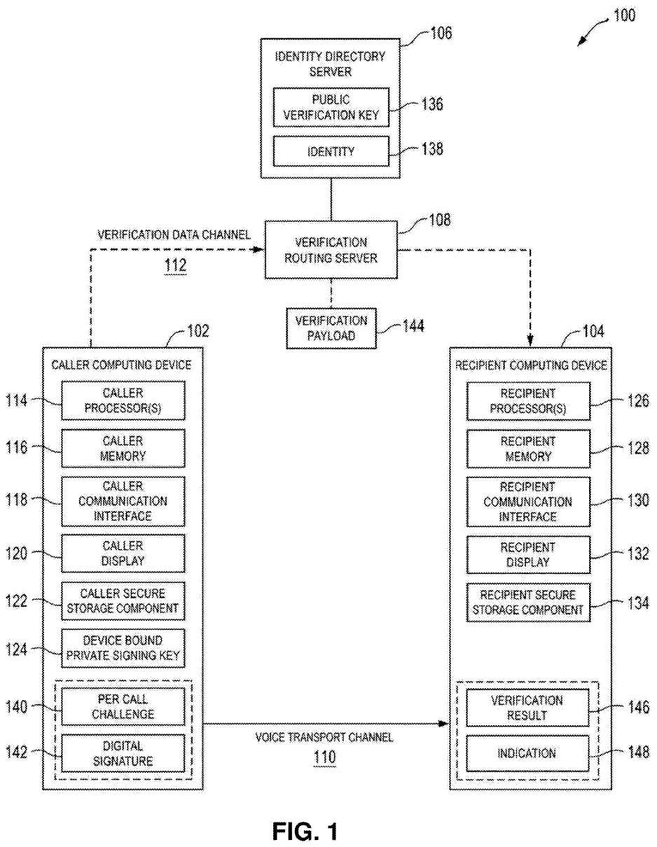

A system for verifying an identity associated with a voice call will now be described with reference to the accompanying drawings, particularly FIGS. 1-14.

FIG. 1 illustrates a general environment 100 for implementing a system for verifying an identity associated with a voice call, according to one or more embodiments of the present invention. The general environment 100 includes a caller computing device 102, a recipient computing device 104, an identity directory server 106, a verification routing server 108, a voice transport channel 110, and a verification data channel 112. The caller computing device 102 and the recipient computing device 104 may each include a mobile phone, a tablet computer, a laptop computer, a desktop computer, a wearable computing device, an enterprise communication device, a vehicle communication device, a satellite communication device, or another computing device capable of participating in a voice call.

In some embodiments, the caller computing device 102 includes one or more caller processors 114, a caller memory 116, a caller communication interface 118, a caller display 120, and a caller secure storage component 122. The caller memory 116 stores instructions that cause the one or more caller processors 114 to perform one or more operations described herein. The caller communication interface 118 communicates over the voice transport channel 110, the verification data channel 112, or both. The caller display 120 presents call information, verification information, or both to a user of the caller computing device 102. The caller secure storage component 122 protects a device bound private signing key 124 associated with the caller computing device 102.

In some embodiments, the caller secure storage component 122 includes a secure enclave, a hardware security module, a trusted execution environment, a hardware backed keystore, a StrongBox keystore, a secure element, a trusted platform module, or another secure component that protects cryptographic key material. In some embodiments, the caller secure storage component 122 generates the device bound private signing key 124 and prevents export of plaintext private key material corresponding to the device bound private signing key 124. In other embodiments, the caller secure storage component 122 wraps, encrypts, gates use of, or otherwise protects the device bound private signing key 124 such that software executing outside the caller secure storage component 122 cannot retrieve plaintext private key material.

In an embodiment, the recipient computing device 104 includes one or more recipient processors 126, a recipient memory 128, a recipient communication interface 130, a recipient display 132, and, in some embodiments, a recipient secure storage component 134. The recipient memory 128 stores instructions that cause the one or more recipient processors 126 to perform one or more operations described herein. The recipient communication interface 130 receives voice call information over the voice transport channel 110 and receives a verification payload over the verification data channel 112. The recipient display 132 presents an indication of a verification result before the voice call is answered at the recipient computing device 104.

In an embodiment, the identity directory server 106 stores a public verification key 136 associated with an identity 138 of a caller. In some embodiments, the identity 138 includes or corresponds to a telephone number, a subscriber identity module identifier, a device identifier, an operating system identity, an enterprise identity, a decentralized identifier, a carrier issued identity, a government issued identity, or another identity anchor. The identity directory server 106 may store a plurality of public verification keys associated with the identity 138 when the caller uses multiple registered devices. The identity directory server 106 may also store key status information, revocation information, key transition records, device records, identity verification records, or combinations thereof.

In an embodiment, a verification routing server 108 routes a verification payload from the caller computing device 102 to the recipient computing device 104 through the verification data channel 112. In some embodiments, the verification routing server 108 forwards the verification payload without determining whether the verification payload proves the identity 138 of the caller. In such embodiments, the recipient computing device 104 generates the verification result locally using the public verification key 136 and does not receive it from the verification routing server 108 or the identity directory server 106. In other embodiments, the verification routing server 108 may deliver status information, message delivery information, or push notification information without determining the verification result.

The voice transport channel 110 carries audio content, call setup information, or both for a particular instance of a voice call between the caller computing device 102 and the recipient computing device 104. The voice transport channel 110 may include a cellular voice channel, a public switched telephone network channel, a Voice over Internet Protocol channel, a satellite voice channel, a native telephony channel of a mobile operating system, an enterprise telephony channel, or another channel that carries a voice communication. In some embodiments, the caller computing device 102 initiates the voice call by invoking a native telephony function of its operating system.

The verification data channel 112 carries the verification payload separate from the voice transport channel 110. The verification data channel 112 may include a push notification channel, a messaging channel, a packet data channel, a signalling channel, a WebRTC data channel, a SIP signalling channel, an RCS channel, a carrier signalling channel, or another data communication channel. In some embodiments, infrastructure that routes the verification payload over the verification data channel 112 does not carry audio content of the voice call. In other embodiments, the same service provider may operate both voice and verification infrastructure, while the verification payload remains logically separate from audio content of the voice call.

During an example operation of the general environment 100, the caller computing device 102 generates a per-call challenge 140 associated with the particular instance of the voice call. The per-call challenge 140 may include a call identifier, a timestamp, a nonce, device information, session information, routing information, contextual metadata, or a combination thereof. The caller computing device 102 produces a digital signature 142 over the per-call challenge 140 using the device-bound private signing key 124. In some embodiments, the caller computing device 102 produces the digital signature 142 only after successful local user authentication, such as biometric authentication, passcode authentication, device unlock authentication, proof of possession of the caller computing device 102, or a combination thereof.

The caller computing device 102 initiates the voice call to the recipient computing device 104 over the voice transport channel 110. The caller computing device 102 also transmits a verification payload 144 to the recipient computing device 104 over the verification data channel 112. The verification payload 144 includes the per call challenge 140 and the digital signature 142. The verification payload 144 may also include a caller identifier, a call identifier, a public key identifier, an algorithm identifier, a timestamp, a nonce, device attestation data, certificate data, routing metadata, or a combination thereof.

The recipient computing device 104 obtains the public verification key 136 associated with the caller's identity 138. In some embodiments, the recipient computing device 104 obtains the public verification key 136 from the identity directory server 106. In other embodiments, the recipient computing device 104 obtains the public verification key 136 from a local cache, a pinned key record, a certificate, a distributed ledger, an enterprise identity provider, a carrier identity system, or another trusted source. The recipient computing device 104 verifies the digital signature 142 using the public verification key 136 to generate a verification result 146. The recipient computing device 104 generates the verification result 146 locally and does not require a server to determine it.

The recipient computing device 104 displays, on the recipient display 132, an indication 148 of the verification result 146 before the voice call is answered at the recipient computing device 104. The indication 148 may include a verified identity message, a not verified message, a warning, an icon, a badge, a banner, an overlay, a notification, a color coded element, a sound, a haptic output, a native call interface element, or a combination thereof. In one example, the recipient computing device 104 displays the indication 148 as an overlay on or adjacent to a native incoming call interface. In another example, the recipient computing device 104 displays the indication 148 within a communication application interface.

In some embodiments, the general environment 100 supports mutual verification. The recipient computing device 104 may generate a recipient per call challenge or a signed response and may transmit a recipient verification payload to the caller computing device 102 through the verification data channel 112. The caller computing device 102 may obtain a recipient public verification key and may locally verify the recipient verification payload to generate a mutual verification result. The caller computing device 102 may display the mutual verification result on the caller display 120 before or during the voice call.

In some embodiments, the general environment 100 supports verified business caller display. For example, one or more servers associated with the system may verify a business entity, validate one or more calling identifiers authorized for use by the business entity, validate one or more brand elements associated with the business entity, and issue or store merchant certificate information. The merchant certificate information may associate a verified business identity with one or more authorized calling identifiers, one or more brand elements, and one or more public verification keys corresponding to one or more device bound private signing keys.

In some embodiments, the one or more servers that support verified business caller display may include the identity directory server 106, the verification routing server 108, a certificate authority, an enterprise identity server, a carrier system, or another server in communication with the caller computing device 102 or the recipient computing device 104. The merchant certificate information may be stored in the identity directory server 106, transmitted with the verification payload 144, cached by the recipient computing device 104, or obtained from another trusted source. The recipient computing device 104 may use the merchant certificate information to determine whether to display a verified business call indication before the voice call is answered.

In some embodiments, the verified business call indication includes a business name, logo, department name, call reason, verified business badge, certificate assurance indication, or other business identity information. The recipient computing device 104 may display the verified business call indication differently from an individual caller verification indication. For example, the recipient computing device 104 may display a verified individual caller using a personal name, telephone number, contact image, or verified person badge, and may display a verified business caller using a business name, logo, department name, call reason, verified business badge, or certificate assurance indication.

The general environment 100 may support different cryptographic algorithms. In some embodiments, the caller computing device 102 produces the digital signature 142 using a post quantum digital signature algorithm. In other embodiments, the caller computing device 102 produces the digital signature 142 using a classical public key digital signature algorithm. In further embodiments, the caller computing device 102 produces the digital signature 142 using a hybrid signature scheme that includes both a post quantum digital signature and a classical public key digital signature. Example algorithms include ML DSA, SLH DSA, Falcon, ECDSA, EdDSA, RSA PSS, or another suitable digital signature algorithm.

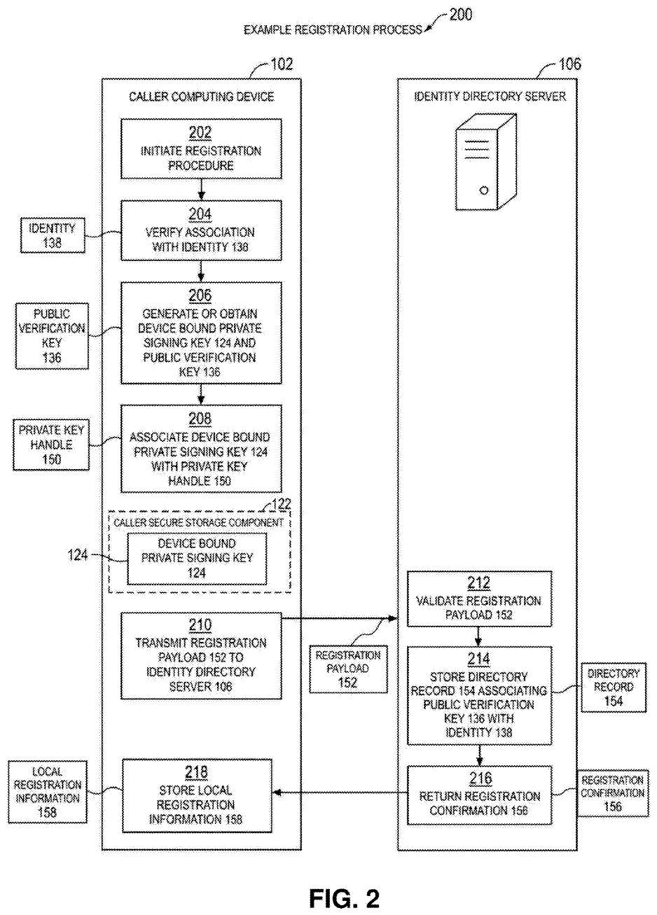

FIG. 2 illustrates an example registration process 200 in which the caller computing device 102 generates or obtains the device bound private signing key 124 and causes the corresponding public verification key 136 to become associated with the identity 138 in the identity directory server 106, according to one or more embodiments of the present invention. Although FIG. 2 describes registration with respect to the caller computing device 102, the recipient computing device 104 may perform the same or similar registration process 200 when the recipient computing device 104 registers with the identity directory server 106.

At step 202, the caller computing device 102 initiates a registration procedure. In some embodiments, a user launches an application on the caller computing device 102 and provides registration information. The registration information may include a telephone number, a subscriber identity module identifier, a device identifier, an operating system identity, an enterprise identity, a decentralized identifier, a carrier issued identity, a government issued identity, or another identity anchor. In other embodiments, an operating system service, an enterprise device management service, a carrier service, or a native telephony component initiates the registration procedure without requiring the user to open a separate application.

At step 204, the caller computing device 102 verifies that the user controls or is associated with the identity 138. In some embodiments, the caller computing device 102 receives a one time code sent to a telephone number associated with the identity 138. In other embodiments, the caller computing device 102 obtains an identity assertion from an identity provider, a carrier system, an enterprise directory, a device management system, a decentralized identity system, or a government identity system. In further embodiments, the caller computing device 102 uses multiple verification factors to establish the association between the user, the caller computing device 102, and the identity 138.

At step 206, the caller computing device 102 generates, receives, derives, or otherwise obtains the device bound private signing key 124 and a corresponding public verification key 136. In some embodiments, the caller secure storage component 122 generates a key pair that includes the device bound private signing key 124 and the public verification key 136. In other embodiments, cryptographic software executing on the caller computing device 102 generates the key pair and immediately causes the caller secure storage component 122 to wrap, encrypt, gate use of, or otherwise protect the device bound private signing key 124. In such embodiments, the caller computing device 102 removes plaintext private key material from software accessible memory after the caller secure storage component 122 protects the device bound private signing key 124.

The caller secure storage component 122 may include a secure enclave, a hardware security module, a trusted execution environment, a hardware backed keystore, a StrongBox keystore, a secure element, a trusted platform module, or another secure component that protects cryptographic key material. In some embodiments, the caller secure storage component 122 prevents export of plaintext private key material corresponding to the device bound private signing key 124. In some embodiments, the caller secure storage component 122 requires local user authentication before allowing the caller computing device 102 to use the device bound private signing key 124 to produce a digital signature.

At step 208, the caller computing device 102 associates the device bound private signing key 124 with a private key handle 150. The private key handle 150 allows software executing on the caller computing device 102 to request signature operations without accessing plaintext private key material corresponding to the device bound private signing key 124. The private key handle 150 may include a key alias, a key reference, an object identifier, a secure enclave reference, a keystore entry identifier, a hardware security module reference, a cryptographic object reference, or another value that identifies the device bound private signing key 124 for permitted signing operations.

At step 210, the caller computing device 102 transmits a registration payload 152 to the identity directory server 106. The registration payload 152 includes the public verification key 136 and information identifying the identity 138. The registration payload 152 may also include the private key handle 150, a public key identifier, an algorithm identifier, a device identifier, device attestation data, certificate data, carrier attestation data, enterprise identity data, revocation contact information, recovery information, or a combination thereof. In some embodiments, the caller computing device 102 transmits the registration payload 152 through an encrypted communication session.

At step 212, the identity directory server 106 validates the registration payload 152. In some embodiments, the identity directory server 106 validates that the identity 138 has not already been registered in a conflicting manner. In some embodiments, the identity directory server 106 validates proof of control of the identity 138. In some embodiments, the identity directory server 106 validates device attestation data indicating that the caller computing device 102 includes or uses the caller secure storage component 122. In some embodiments, the identity directory server 106 validates an algorithm identifier associated with the public verification key 136. The identity directory server 106 may reject the registration payload 152 when the registration payload 152 fails one or more validation checks.

At step 214, the identity directory server 106 stores a directory record 154 that associates the public verification key 136 with the identity 138. The directory record 154 may also associate the public verification key 136 with a public key identifier, an algorithm identifier, a device identifier, a device type, a registration time, a key status, an expiration time, a revocation status, an identity assurance level, an attestation record, or a combination thereof. The identity directory server 106 may store multiple directory records for the identity 138 when multiple computing devices correspond to the same identity 138.

At step 216, the identity directory server 106 returns a registration confirmation 156 to the caller computing device 102. The registration confirmation 156 may include the public key identifier, a directory record identifier, a registration timestamp, a key status, identity assurance information, or other information confirming that the identity directory server 106 has associated the public verification key 136 with the identity 138. The caller computing device 102 may store the registration confirmation 156 in the caller memory 116 or in another storage location on the caller computing device 102.

At step 218, the caller computing device 102 stores local registration information 158. The local registration information 158 may include the private key handle 150, the public key identifier, the algorithm identifier, the identity 138, the registration timestamp, a directory endpoint, key status information, or a combination thereof. The caller computing device 102 may use the local registration information 158 during a later call initiation process to identify the device bound private signing key 124 and to produce the digital signature 142 over the per call challenge 140.

In some embodiments, the registration process 200 supports a post quantum digital signature algorithm, a classical public key digital signature algorithm, or a hybrid signature scheme. For example, the caller computing device 102 may generate or obtain a key pair for ML DSA, SLH DSA, Falcon, ECDSA, EdDSA, RSA PSS, another suitable digital signature algorithm, or a combination thereof. The identity directory server 106 may store the algorithm identifier with the public verification key 136 so that the recipient computing device 104 can later select a corresponding verification operation.

In some embodiments, the registration process 200 supports key pinning and later detection of unexpected key changes. For example, after the identity directory server 106 stores the directory record 154, another computing device that retrieves the public verification key 136 may store the public verification key 136 as a pinned public verification key. If the other computing device later obtains a different public verification key for the same identity 138, the other computing device may display a key change warning or require additional authentication before treating the different public verification key as trusted.

In some embodiments, the registration process 200 supports multiple devices for the same identity 138. For example, the identity directory server 106 may store a first public verification key associated with a mobile phone and a second public verification key associated with a tablet computer, both associated with the identity 138. During a later verification process, the recipient computing device 104 may generate the verification result 146 by determining whether the digital signature 142 verifies against at least one public verification key associated with the identity 138.

In some embodiments, the registration process 200 supports revocation, recovery, and rotation. For example, the identity directory server 106 may mark the public verification key 136 as revoked when a user reports loss of the caller computing device 102. As another example, the caller computing device 102 may rotate the device bound private signing key 124 by generating a replacement public verification key and causing a key transition record to be stored in the identity directory server 106. The key transition record may include the replacement public verification key signed using the device bound private signing key 124.

The registration process 200 allows the identity directory server 106 to provide the public verification key 136 to the recipient computing device 104 during a later voice call while avoiding storage of plaintext private key material at the identity directory server 106. The caller computing device 102 retains control over use of the device bound private signing key 124, and the recipient computing device 104 can later use the public verification key 136 to verify the digital signature 142 associated with the particular instance of the voice call.

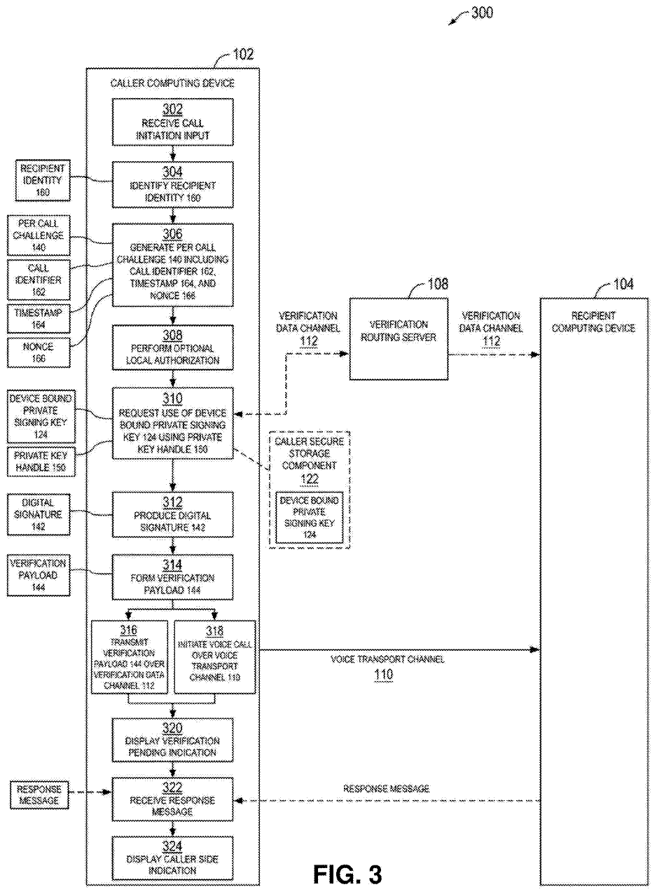

FIG. 3 illustrates an example call initiation process 300 in which the caller computing device 102 generates the per call challenge 140, produces the digital signature 142 over the per call challenge 140, initiates the voice call over the voice transport channel 110, and transmits the verification payload 144 over the verification data channel 112 separate from the voice transport channel 110, according to one or more embodiments of the present invention. The call initiation process 300 may occur after the registration process 200 associates the public verification key 136 with the identity 138 in the identity directory server 106.

At step 302, the caller computing device 102 receives a call initiation input. In some embodiments, the call initiation input includes a user selection of a contact, a user entry of a telephone number, a user selection of a call control, a voice command, an enterprise directory selection, a call back request, or another input indicating that the user intends to initiate the voice call to the recipient computing device 104. In other embodiments, an operating system service, an enterprise communication platform, a carrier service, or another authorized component generates the call initiation input.

At step 304, the caller computing device 102 identifies a recipient identity 160 associated with the recipient computing device 104. The recipient identity 160 may include a telephone number, a contact identifier, a subscriber identity module identifier, a device identifier, an operating system identity, an enterprise identity, a decentralized identifier, a carrier issued identity, a government issued identity, or another identity anchor associated with a recipient. In some embodiments, the caller computing device 102 queries the identity directory server 106 to determine whether the recipient identity 160 corresponds to a registered user or a registered device.

At step 306, the caller computing device 102 generates the per call challenge 140 associated with a particular instance of the voice call. In some embodiments, the per call challenge 140 includes a call identifier 162, a timestamp 164, and a nonce 166. The call identifier 162 identifies the particular instance of the voice call. The timestamp 164 indicates a time associated with generation of the per call challenge 140 or initiation of the voice call. The nonce 166 includes a random or pseudorandom value generated for the particular instance of the voice call. In other embodiments, the per call challenge 140 also includes the identity 138, the recipient identity 160, device information, session information, routing information, a public key identifier, an algorithm identifier, contextual metadata, or a combination thereof.

At step 308, the caller computing device 102 optionally performs a local authorization operation before producing the digital signature 142. The local authorization operation may include biometric authentication, passcode authentication, device unlock verification, possession verification, user presence verification, enterprise policy verification, device attestation verification, or a combination thereof. In some embodiments, the caller computing device 102 does not produce the digital signature 142 when the local authorization operation fails.

At step 310, the caller computing device 102 requests use of the device bound private signing key 124. In some embodiments, the caller computing device 102 uses the private key handle 150 to request that the caller secure storage component 122 produce the digital signature 142. The private key handle 150 may identify the device bound private signing key 124 without exposing plaintext private key material to application software, an operating system process, the verification routing server 108, the identity directory server 106, or another external component.

At step 312, the caller computing device 102 produces the digital signature 142 over the per call challenge 140 using the device bound private signing key 124. In some embodiments, the caller secure storage component 122 performs a signing operation using the device bound private signing key 124 and returns the digital signature 142 to software executing on the caller computing device 102. In other embodiments, software executing on the caller computing device 102 performs a signing operation using private key material that the caller secure storage component 122 has wrapped, encrypted, gated, or otherwise protected. In each such embodiment, the caller computing device 102 prevents export of plaintext private key material corresponding to the device bound private signing key 124 outside an authorized protection boundary.

In some embodiments, the caller computing device 102 produces the digital signature 142 using a post quantum digital signature algorithm, a classical public key digital signature algorithm, or a hybrid signature scheme. For example, the caller computing device 102 may produce the digital signature 142 using ML DSA, SLH DSA, Falcon, ECDSA, EdDSA, RSA PSS, another suitable asymmetric digital signature algorithm, or a combination thereof. In some embodiments, the caller computing device 102 includes an algorithm identifier in the verification payload 144 so that the recipient computing device 104 can select a corresponding verification operation.

At step 314, the caller computing device 102 forms the verification payload 144 The verification payload 144 includes the per call challenge 140 and the digital signature 142. In some embodiments, the verification payload 144 also includes the identity 138, the recipient identity 160, the call identifier 162, the timestamp 164, the nonce 166, the public key identifier, the algorithm identifier, device attestation data, certificate data, routing metadata, a caller display name, a telephone number, or a combination thereof. In some embodiments, the caller computing device 102 formats the verification payload 144 as a structured data object, such as a JSON object, a CBOR object, a protocol buffer message, a token, a certificate extension, a call signaling field, or another machine readable format.

At step 316, the caller computing device 102 transmits the verification payload 144 to the recipient computing device 104 over the verification data channel 112. In some embodiments, the caller computing device 102 transmits the verification payload 144 to the verification routing server 108, and the verification routing server 108 forwards the verification payload 144 to the recipient computing device 104. In other embodiments, the caller computing device 102 transmits the verification payload 144 directly to the recipient computing device 104 through a peer to peer data channel, a signaling channel, a carrier channel, or another communication path. The verification data channel 112 may include a push notification channel, a messaging channel, a packet data channel, a WebRTC data channel, a SIP signaling channel, an RCS channel, a carrier signaling channel, or another data communication channel.

At step 318, the caller computing device 102 initiates the voice call to the recipient computing device 104 over the voice transport channel 110. In some embodiments, the caller computing device 102 invokes a native telephony function of an operating system of the caller computing device 102 to place a standard telephone call to a telephone number associated with the recipient identity 160. In other embodiments, the caller computing device 102 initiates the voice call using a cellular voice service, a public switched telephone network service, a Voice over Internet Protocol service, a satellite voice service, an enterprise telephony service, or another voice communication service.

In some embodiments, the caller computing device 102 performs step 316 and step 318 in parallel or in close temporal proximity. For example, the caller computing device 102 may transmit the verification payload 144 over the verification data channel 112 while the operating system of the caller computing device 102 places the voice call over the voice transport channel 110. In another example, the caller computing device 102 may transmit the verification payload 144 before, during, or after call setup signaling for the voice call. The timing may vary as long as the recipient computing device 104 can generate the verification result 146 before or during presentation of the incoming voice call.

At step 320, the caller computing device 102 optionally displays a verification pending indication on the caller display 120. The verification pending indication may inform the user of the caller computing device 102 that the caller computing device 102 has transmitted the verification payload 144 or that the recipient computing device 104 has not yet generated or returned the verification result 146. The verification pending indication may include a message, an icon, a badge, a banner, a status indicator, a progress indicator, a sound, a haptic output, or another user interface element.

At step 322, the caller computing device 102 may receive a response message from the recipient computing device 104, the verification routing server 108, or both. The response message may include a delivery confirmation, a verification result 146 generated by the recipient computing device 104, a recipient verification payload, a recipient per call challenge, a signed response, a mutual verification result, or a combination thereof. In some embodiments, the verification routing server 108 routes the response message without determining the verification result 146.

At step 324, the caller computing device 102 optionally displays a caller side indication associated with the response message. For example, the caller computing device 102 may display that the recipient computing device 104 has verified the identity 138 of the caller. As another example, the caller computing device 102 may display a mutual verification result indicating whether the caller computing device 102 has verified an identity associated with the recipient computing device 104. The caller side indication may appear before the voice call connects, during call setup, after the voice call is answered, or during the voice call.

In some embodiments, the caller computing device 102 does not transmit audio content of the voice call through the verification routing server 108. For example, the caller computing device 102 may place the voice call through a native telephony service while the verification routing server 108 routes only the verification payload 144. In other embodiments, a common service provider may operate both a voice service and a verification service, but the verification payload 144 remains logically separate from the audio content of the voice call.

The call initiation process 300 allows the caller computing device 102 to bind the verification payload 144 to the particular instance of the voice call through the per call challenge 140. Because the caller computing device 102 produces the digital signature 142 over the per call challenge 140 using the device bound private signing key 124, the recipient computing device 104 can later use the public verification key 136 to determine whether the verification payload 144 corresponds to a device associated with the identity 138 of the caller.

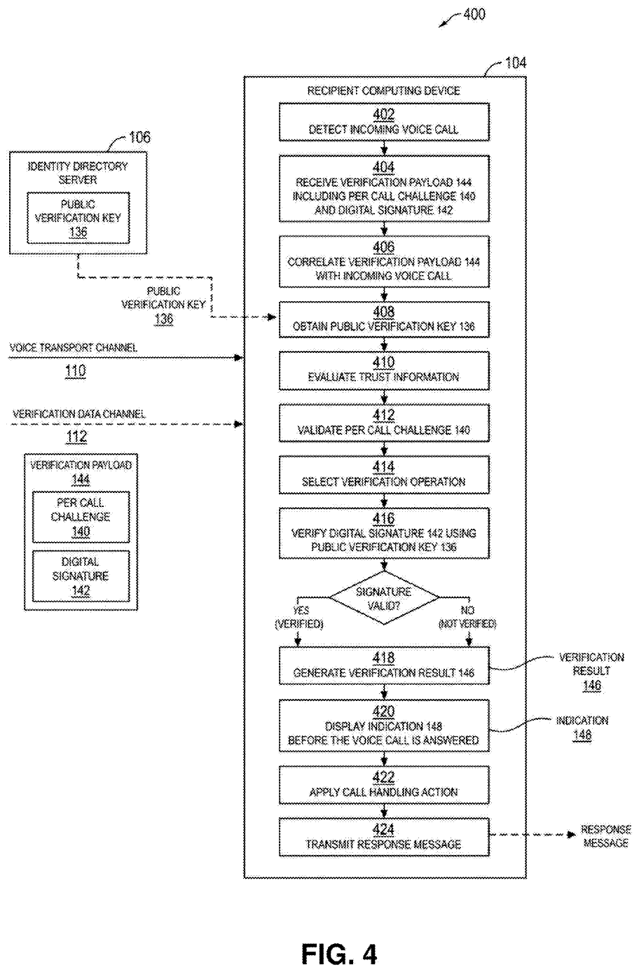

FIG. 4 illustrates an example recipient verification process 400 in which the recipient computing device 104 receives the verification payload 144, obtains the public verification key 136, locally verifies the digital signature 142, and generates the verification result 146, according to one or more embodiments of the present invention. The recipient verification process 400 may occur when the recipient computing device 104 receives the voice call over the voice transport channel 110 and receives the verification payload 144 over the verification data channel 112.

At step 402, the recipient computing device 104 detects the incoming voice call associated with the caller computing device 102. In some embodiments, the recipient computing device 104 detects the incoming voice call through a native telephony interface of an operating system of the recipient computing device 104. In other embodiments, the recipient computing device 104 detects the incoming voice call through a communication application, an enterprise telephony application, a carrier application, a satellite communication application, a Voice over Internet Protocol application, or another voice communication component.

At step 404, the recipient computing device 104 receives the verification payload 144 over the verification data channel 112. The verification payload 144 includes the per call challenge 140 and the digital signature 142. In some embodiments, the verification payload 144 also includes the identity 138 of the caller, the recipient identity 160, the call identifier 162, the timestamp 164, the nonce 166, a public key identifier, an algorithm identifier, device attestation data, certificate data, routing metadata, a caller display name, a telephone number, or a combination thereof. The verification data channel 112 may include a push notification channel, a messaging channel, a packet data channel, a signalling channel, a WebRTC data channel, a SIP signalling channel, an RCS channel, a carrier signalling channel, or another data communication channel.

At step 406, the recipient computing device 104 correlates the verification payload 144 with the incoming voice call. In some embodiments, the recipient computing device 104 correlates the verification payload 144 with the incoming voice call by comparing a caller telephone number, a caller identifier, the identity 138, the recipient identity 160, the call identifier 162, call setup information, routing information, timing information, or a combination thereof. In some embodiments, the recipient computing device 104 determines that the verification payload 144 corresponds to the incoming voice call when the verification payload 144 arrives within a predetermined time window relative to detection of the incoming voice call.

At step 408, the recipient computing device 104 obtains the public verification key 136 associated with the identity 138 of the caller. In some embodiments, the recipient computing device 104 obtains the public verification key 136 from the identity directory server 106. In other embodiments, the recipient computing device 104 obtains the public verification key 136 from a local cache, a pinned public key record, a certificate, an enterprise identity provider, a carrier identity system, a decentralized identity system, a distributed ledger, a contact record, or another trusted source. In some embodiments, the recipient computing device 104 obtains a plurality of public verification keys associated with the identity 138 and later determines whether the digital signature 142 verifies against at least one public verification key of the plurality of public verification keys.

At step 410, the recipient computing device 104 evaluates trust information associated with the public verification key 136. In some embodiments, the recipient computing device 104 determines whether the public verification key 136 has a valid key status, a valid revocation status, a valid expiration status, a valid identity assurance level, a valid certificate chain, a valid directory response, a valid device attestation record, or a combination thereof. In some embodiments, the recipient computing device 104 compares the public verification key 136 with a pinned public verification key stored by the recipient computing device 104. When the public verification key 136 differs from the pinned public verification key, the recipient computing device 104 may display a key change warning, reduce a trust level, request additional authentication, or treat verification as unsuccessful.

At step 412, the recipient computing device 104 validates the per call challenge 140. In some embodiments, the recipient computing device 104 determines whether the per call challenge 140 includes the call identifier 162, the timestamp 164, and the nonce 166. In some embodiments, the recipient computing device 104 determines whether the timestamp 164 falls within a predetermined recency window. In some embodiments, the recipient computing device 104 determines whether the nonce 166 has sufficient length or randomness, whether the call identifier 162 has not previously appeared, whether the per call challenge 140 matches the incoming voice call, whether the recipient identity 160 corresponds to the recipient computing device 104, or whether contextual metadata in the per call challenge 140 satisfies a policy.

At step 414, the recipient computing device 104 selects a verification operation. In some embodiments, the recipient computing device 104 selects the verification operation based on an algorithm identifier in the verification payload 144, the public verification key 136, a directory record, a certificate, or a local policy. The verification operation may correspond to a post quantum digital signature algorithm, a classical public key digital signature algorithm, or a hybrid signature scheme. Example algorithms include ML DSA, SLH DSA, Falcon, ECDSA, EdDSA, RSA PSS, or another suitable digital signature algorithm.

At step 416, the recipient computing device 104 verifies the digital signature 142 using the public verification key 136. The recipient computing device 104 performs the verification operation over the per call challenge 140 and the digital signature 142. In some embodiments, the recipient computing device 104 performs the verification operation entirely locally using the one or more recipient processors 126. In such embodiments, the identity directory server 106, the verification routing server 108, and any other server do not determine the verification result 146. In other embodiments, the recipient computing device 104 may use a local trusted execution environment, a local secure element, a local cryptographic library, or a local operating system cryptographic service to perform the verification operation.

At step 418, the recipient computing device 104 generates the verification result 146. In some embodiments, the verification result 146 indicates successful verification when the digital signature 142 verifies using the public verification key 136 and when one or more policy checks satisfy a verification policy. The one or more policy checks may include recency validation, nonce validation, call correlation validation, revocation validation, key pinning validation, identity assurance validation, device attestation validation, or a combination thereof. In some embodiments, the verification result 146 indicates unsuccessful verification when the digital signature 142 fails to verify, when the public verification key 136 has an invalid status, when the timestamp 164 falls outside the predetermined recency window, when the verification payload 144 fails to correlate with the incoming voice call, or when another policy check fails.

At step 420, the recipient computing device 104 displays the indication 148 of the verification result 146 on the recipient display 132 before the voice call is answered at the recipient computing device 104. In some embodiments, the indication 148 includes a verified identity message when the verification result 146 indicates successful verification. In some embodiments, the indication 148 includes a not verified message, a warning, or another risk indication when the verification result 146 indicates unsuccessful verification. The indication 148 may include an overlay, notification, banner, badge, icon, warning, haptic output, sound, native call interface element, application interface element, or a combination thereof.

In one example, the recipient computing device 104 displays the indication 148 as an overlay on or adjacent to a native incoming call interface of the recipient computing device 104. In another example, the recipient computing device 104 displays the indication 148 within a communication application that receives the voice call. In another example, the recipient computing device 104 displays the indication 148 through a carrier controlled call display interface, an enterprise call display interface, or an operating system telephony interface.

At step 422, the recipient computing device 104 may apply one or more call handling actions based on the verification result 146. In some embodiments, the recipient computing device 104 allows normal call answering when the verification result 146 indicates successful verification. In some embodiments, the recipient computing device 104 displays an enhanced warning, suppresses the automatic answer function, routes the voice call to voicemail, blocks the voice call, records a security event, requests additional authentication, or performs another call-handling action when the verification result 146 indicates unsuccessful verification. In some embodiments, the recipient computing device 104 allows a user to answer the voice call even if the verification is unsuccessful.

At step 424, the recipient computing device 104 may transmit a response message to the caller computing device 102, the verification routing server 108, or both. The response message may include the verification result 146, a delivery confirmation, a call correlation status, a recipient verification payload, a recipient per-call challenge, a signed response, a mutual verification status, or any combination thereof. In some embodiments, the verification routing server 108 routes the response message without determining the verification result 146.

In some embodiments, the recipient computing device 104 performs the recipient verification process 400 using the public verification key 136 obtained from a local cache when the identity directory server 106 cannot be reached. For example, the recipient computing device 104 may use a cached public verification key that remains valid under a local validity policy. The local validity policy may consider a cache age, a prior key pinning status, a prior revocation status, an identity assurance level, a network availability condition, or a combination thereof.

In some embodiments, the recipient computing device 104 uses additional authentication information to generate the verification result 146. For example, the recipient computing device 104 may evaluate device attestation data, subscriber identity module status, location consistency, account authentication status, enterprise identity provider data, biometric status, device unlock status, or other authentication information in addition to verifying the digital signature 142. In such embodiments, the verification result 146 may indicate different assurance levels rather than only successful verification or unsuccessful verification.

The recipient verification process 400 allows the recipient computing device 104 to determine whether the verification payload 144 corresponds to a device associated with the caller's identity 138 and to present the indication 148 before the user answers the voice call. The recipient verification process 400 also allows the identity directory server 106 and the verification routing server 108 to support key retrieval and message routing while the recipient computing device 104 generates the verification result 146 locally.

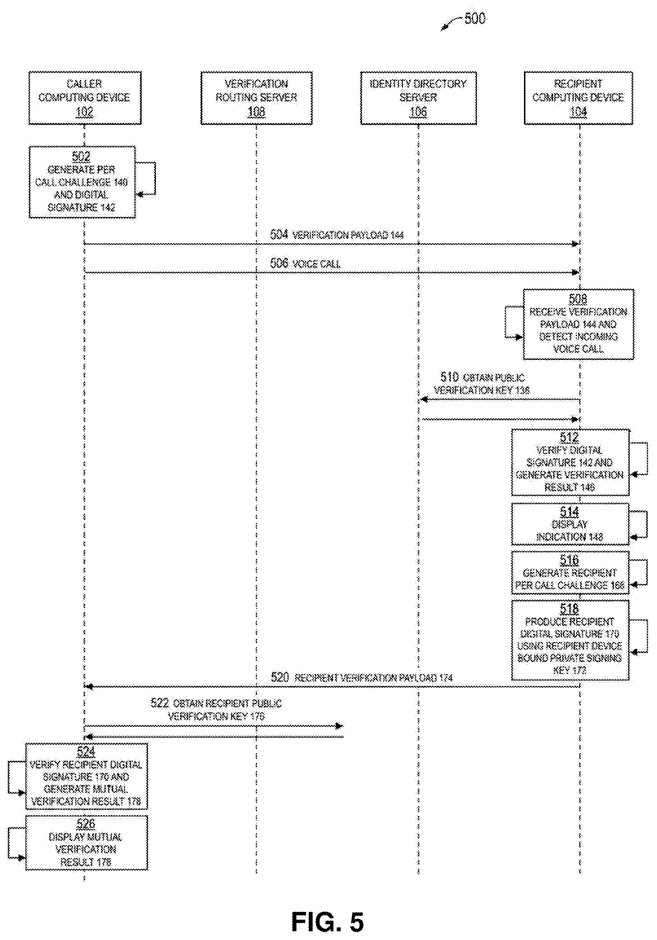

FIG. 5 illustrates an example mutual verification process 500 in which the caller computing device 102 and the recipient computing device 104 each verify an identity associated with the other computing device during the particular instance of the voice call, according to one or more embodiments of the present invention. The mutual verification process 500 may occur in connection with the call initiation process 300 of FIG. 3 and the recipient verification process 400 of FIG. 4.

At step 502, the caller computing device 102 initiates the mutual verification process 500 by generating the per call challenge 140 and producing the digital signature 142 using the device bound private signing key 124. The caller computing device 102 may perform step 502 in the same manner described with respect to step 306 and step 312 of FIG. 3. The per call challenge 140 may include the call identifier 162, the timestamp 164, the nonce 166, the identity 138 of the caller, the recipient identity 160, or a combination thereof.

At step 504, the caller computing device 102 transmits the verification payload 144 toward the recipient computing device 104 over the verification data channel 112. The verification payload 144 includes the per call challenge 140 and the digital signature 142. In some embodiments, the verification routing server 108 routes the verification payload 144 to the recipient computing device 104 without determining whether the digital signature 142 verifies.

At step 506, the caller computing device 102 initiates the voice call to the recipient computing device 104 over the voice transport channel 110. In some embodiments, the caller computing device 102 performs step 504 and step 506 in parallel or in close temporal proximity so that the recipient computing device 104 can receive the verification payload 144 before or while the recipient computing device 104 presents an incoming call interface for the voice call.

At step 508, the recipient computing device 104 receives the verification payload 144 over the verification data channel 112 and detects the incoming voice call over the voice transport channel 110. The recipient computing device 104 may correlate the verification payload 144 with the incoming voice call using the call identifier 162, the identity 138, the recipient identity 160, timing information, call setup information, routing information, or a combination thereof.

At step 510, the recipient computing device 104 obtains the public verification key 136 associated with the identity 138 of the caller. The recipient computing device 104 may obtain the public verification key 136 from the identity directory server 106, a local cache, a pinned public key record, a certificate, an enterprise identity provider, a carrier identity system, a decentralized identity system, a distributed ledger, or another trusted source.

At step 512, the recipient computing device 104 verifies the digital signature 142 using the public verification key 136 and generates the verification result 146. In some embodiments, the recipient computing device 104 generates the verification result 146 locally without receiving the verification result 146 from the identity directory server 106, the verification routing server 108, or another server. The recipient computing device 104 may also validate the call identifier 162, the timestamp 164, the nonce 166, key status information, revocation status information, call correlation information, or a combination thereof.

At step 514, the recipient computing device 104 displays the indication 148 of the verification result 146 before the voice call is answered at the recipient computing device 104. The indication 148 may include a verified identity message, a not verified message, a warning, an icon, a badge, a banner, an overlay, a notification, a native call interface element, an application interface element, a sound, a haptic output, or a combination thereof.

At step 516, the recipient computing device 104 generates a recipient per call challenge 168 associated with the same particular instance of the voice call. In some embodiments, the recipient per call challenge 168 includes the call identifier 162, a recipient timestamp, a recipient nonce, the identity 138, the recipient identity 160, device information, session information, routing information, or a combination thereof. The recipient per call challenge 168 may include data from the per call challenge 140, may include a hash of the per call challenge 140, or may include a newly generated challenge value.

At step 518, the recipient computing device 104 produces a recipient digital signature 170 over the recipient per call challenge 168 using a recipient device bound private signing key 172 associated with the recipient computing device 104. In some embodiments, the recipient device bound private signing key 172 resides in, remains protected by, or otherwise operates with the recipient secure storage component 134. The recipient secure storage component 134 may include a secure enclave, a hardware security module, a trusted execution environment, a hardware backed keystore, a StrongBox keystore, a secure element, a trusted platform module, or another secure component that protects cryptographic key material.

At step 520, the recipient computing device 104 transmits a recipient verification payload 174 toward the caller computing device 102 over the verification data channel 112. The recipient verification payload 174 includes the recipient per call challenge 168 and the recipient digital signature 170. In some embodiments, the recipient verification payload 174 also includes the call identifier 162, the identity 138, the recipient identity 160, an algorithm identifier, a public key identifier, device attestation data, certificate data, routing metadata, the verification result 146, or a combination thereof. In some embodiments, the verification routing server 108 routes the recipient verification payload 174 to the caller computing device 102 without determining whether the recipient digital signature 170 verifies.

At step 522, the caller computing device 102 obtains a recipient public verification key 176 associated with the recipient identity 160. The caller computing device 102 may obtain the recipient public verification key 176 from the identity directory server 106, a local cache, a pinned public key record, a certificate, an enterprise identity provider, a carrier identity system, a decentralized identity system, a distributed ledger, or another trusted source.

At step 524, the caller computing device 102 verifies the recipient digital signature 170 using the recipient public verification key 176 and generates a mutual verification result 178. In some embodiments, the caller computing device 102 generates the mutual verification result 178 locally without receiving the mutual verification result 178 from the identity directory server 106, the verification routing server 108, or another server. The caller computing device 102 may also validate the recipient per call challenge 168, the call identifier 162, a recipient timestamp, a recipient nonce, key status information, revocation status information, call correlation information, or a combination thereof.

At step 526, the caller computing device 102 displays an indication of the mutual verification result 178 on the caller display 120. The indication of the mutual verification result 178 may include a verified recipient message, a recipient not verified message, a warning, an icon, a badge, a banner, a notification, an application interface element, a native call interface element, a sound, a haptic output, or a combination thereof. In some embodiments, the caller computing device 102 displays the indication of the mutual verification result 178 before the voice call connects, while the voice call rings, after the recipient computing device 104 answers the voice call, or during the voice call.

In some embodiments, the recipient computing device 104 produces the recipient digital signature 170 as a signed response to the per call challenge 140 instead of, or in addition to, producing the recipient digital signature 170 over the recipient per call challenge 168. For example, the recipient computing device 104 may sign the call identifier 162, a hash of the per call challenge 140, the verification result 146, and a recipient nonce. The caller computing device 102 may verify the signed response using the recipient public verification key 176 and may treat successful verification of the signed response as proof that the recipient computing device 104 participated in the same particular instance of the voice call.

In some embodiments, the mutual verification process 500 supports different assurance levels. For example, the recipient computing device 104 may display a first assurance level when the digital signature 142 verifies and the timestamp 164 falls within a predetermined recency window. The recipient computing device 104 may display a second assurance level when the digital signature 142 verifies, the timestamp 164 falls within the predetermined recency window, and device attestation data satisfies a device attestation policy. The caller computing device 102 may similarly display different assurance levels based on verification of the recipient digital signature 170 and additional policy checks.

In some embodiments, the mutual verification process 500 uses the same verification data channel 112 for both the verification payload 144 and the recipient verification payload 174. In other embodiments, the mutual verification process 500 uses different data channels for the verification payload 144 and the recipient verification payload 174. For example, the caller computing device 102 may send the verification payload 144 through a push notification channel, and the recipient computing device 104 may send the recipient verification payload 174 through a messaging channel, a WebRTC data channel, a SIP signalling channel, an RCS channel, a carrier signalling channel, or another data communication channel.

In some embodiments, the mutual verification process 500 occurs automatically without requiring the user of the caller computing device 102 or the user of the recipient computing device 104 to manually approve a verification request. In other embodiments, either computing device may require local user authentication, user presence, enterprise policy approval, or another authorization condition before producing a digital signature. Such local user authentication may include biometric authentication, passcode authentication, device unlock authentication, possession of the computing device, or a combination thereof.

The mutual verification process 500 allows the recipient computing device 104 to verify the identity 138 of the caller and allows the caller computing device 102 to verify the recipient identity 160 during the same particular instance of the voice call. By using the verification data channel 112 separate from the voice transport channel 110, the mutual verification process 500 can operate with native telephony calls, carrier calls, Voice over Internet Protocol calls, satellite calls, enterprise calls, or other voice calls while allowing each computing device to generate its own verification result locally.

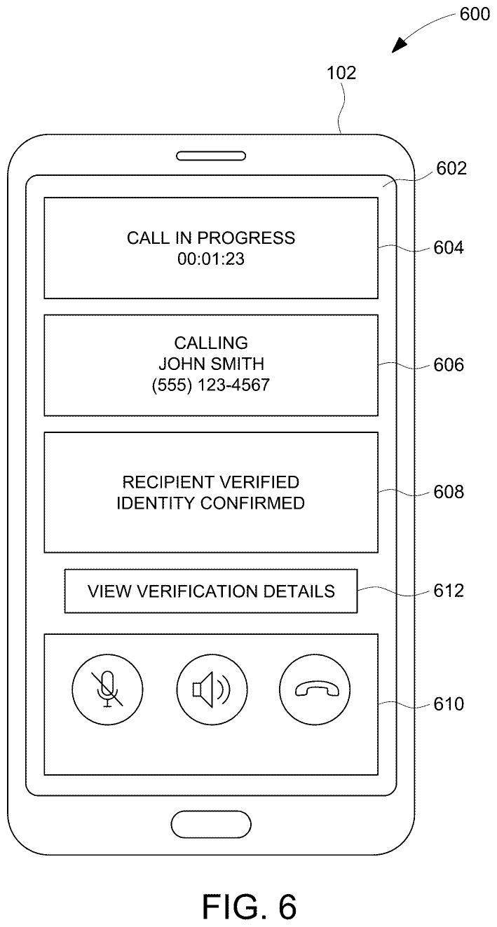

FIG. 6 illustrates an example caller user interface 600 of the caller computing device 102 displaying an indication of the mutual verification result 178 associated with the recipient computing device 104, according to one or more embodiments of the present invention. The caller user interface 600 may appear on the caller display 120 before the voice call connects, while the voice call rings, after the recipient computing device 104 answers the voice call, or during the voice call.

The caller user interface 600 includes a caller device display area 602. The caller device display area 602 may correspond to the caller display 120 of the caller computing device 102. In some embodiments, the caller device display area 602 forms part of a communication application interface. In other embodiments, the caller device display area 602 forms part of a native telephony interface, an operating system call interface, an enterprise communication interface, a carrier call interface, a vehicle communication interface, a wearable device interface, or another user interface capable of presenting call information and verification information.

The caller user interface 600 includes a call status region 604. The call status region 604 presents a status of the voice call. The status of the voice call may include calling, ringing, connecting, connected, verifying, verified, not verified, ended, missed, failed, or another call status. In one example, the call status region 604 displays a calling status while the caller computing device 102 initiates the voice call to the recipient computing device 104 over the voice transport channel 110 and transmits the verification payload 144 over the verification data channel 112.

The caller user interface 600 includes a recipient identity region 606. The recipient identity region 606 presents information associated with the recipient identity 160. The information associated with the recipient identity 160 may include a recipient name, a telephone number, a contact name, an enterprise name, a device name, an account identifier, an image, an avatar, a role, an organization, or a combination thereof. The caller computing device 102 may obtain the information associated with the recipient identity 160 from a contact record, the identity directory server 106, an enterprise directory, a carrier directory, a decentralized identity record, a local contact database, or another source.

The caller user interface 600 includes a verification status region 608. The verification status region 608 displays an indication of the mutual verification result 178. In some embodiments, the verification status region 608 displays a verified recipient indication when the caller computing device 102 verifies the recipient digital signature 170 using the recipient public verification key 176 and determines that the recipient verification payload 174 satisfies one or more verification policies. The verified recipient indication may include text, an icon, a badge, a banner, a shield symbol, a check symbol, a sound, a haptic output, a colour coded element, or another user interface element indicating that the recipient identity 160 has been verified.

In some embodiments, the verification status region 608 displays a verification pending indication before the caller computing device 102 generates the mutual verification result 178. For example, the verification status region 608 may display the verification pending indication after the caller computing device 102 transmits the verification payload 144 and before the caller computing device 102 receives the recipient verification payload 174. The verification pending indication may include text, an icon, a progress indicator, a spinner, a banner, a sound, a haptic output, or another user interface element indicating that verification remains in progress.

In some embodiments, the verification status region 608 displays a recipient not verified indication when the caller computing device 102 fails to verify the recipient digital signature 170, when the caller computing device 102 cannot obtain the recipient public verification key 176, when the recipient per call challenge 168 falls outside a predetermined recency window, when the recipient verification payload 174 fails to correlate with the particular instance of the voice call, when a public key associated with the recipient identity 160 has an invalid status, or when another verification policy fails. The recipient not verified indication may include a warning, an alert, text, an icon, a badge, a banner, a sound, a haptic output, a color coded element, or another user interface element indicating that the recipient identity 160 has not been verified.

The caller user interface 600 may include one or more call control elements 610 The one or more call control elements 610 may include a mute control, a speaker control, an end call control, a keypad control, an add call control, a transfer control, a hold control, a record control, a report call control, or another control associated with the voice call. In some embodiments, the caller computing device 102 enables, disables, highlights, suppresses, or modifies one or more of the call control elements 610 based on the mutual verification result 178.

In some embodiments, the caller user interface 600 includes a verification detail control 612. The verification detail control 612 allows a user of the caller computing device 102 to view additional information associated with the mutual verification result 178. The additional information may include an identity assurance level, an algorithm identifier, a public key identifier, a key status, a timestamp validation status, a device attestation status, a revocation status, a directory lookup status, a local user authentication status, or a combination thereof. The caller computing device 102 may present the additional information in response to user selection of the verification detail control 612.

In some embodiments, the caller computing device 102 displays the verification status region 608 before the voice call connects. For example, when the recipient computing device 104 sends the recipient verification payload 174 before answering the voice call, the caller computing device 102 may verify the recipient digital signature 170 and display the mutual verification result 178 while the voice call rings. In other embodiments, the caller computing device 102 displays or updates the verification status region 608 after the recipient computing device 104 answers the voice call or during the voice call.

In some embodiments, the caller user interface 600 displays different assurance levels. For example, the verification status region 608 may display a first assurance level when the recipient digital signature 170 verifies using the recipient public verification key 176. The verification status region 608 may display a second assurance level when the recipient digital signature 170 verifies and the recipient per call challenge 168 satisfies a recency policy. The verification status region 608 may display a third assurance level when the recipient digital signature 170 verifies, the recipient per call challenge 168 satisfies the recency policy, and device attestation data associated with the recipient computing device 104 satisfies a device attestation policy.

In some embodiments, the caller user interface 600 appears as a full screen interface of an application executing on the caller computing device 102. In other embodiments, the caller user interface 600 appears as a compact call interface, a notification, a banner, a widget, a picture in picture interface, a native operating system call interface, a carrier provided call interface, a vehicle display interface, a wearable display interface, or another interface. The caller computing device 102 may adapt the caller user interface 600 based on a device type, an operating system permission, an application state, a call state, an enterprise policy, a user setting, or a combination thereof.

In one example, the caller computing device 102 initiates a standard cellular call to the recipient computing device 104 through a native telephony function. The caller computing device 102 also transmits the verification payload 144 through a push notification channel. The recipient computing device 104 verifies the verification payload 144, produces the recipient verification payload 174, and transmits the recipient verification payload 174 to the caller computing device 102. The caller computing device 102 verifies the recipient verification payload 174 and displays a verified recipient indication in the verification status region 608 before the recipient answers the standard cellular call.

In another example, the caller computing device 102 initiates a Voice over Internet Protocol call to the recipient computing device 104. The caller computing device 102 transmits the verification payload 144 through a signaling channel associated with call setup. The recipient computing device 104 returns the recipient verification payload 174 through the same signaling channel or a different data channel. The caller computing device 102 displays the mutual verification result 178 in the caller user interface 600 before or during the Voice over Internet Protocol call.

The caller user interface 600 allows the user of the caller computing device 102 to receive visible feedback regarding whether the recipient identity 160 has been verified. The caller user interface 600 also allows the caller computing device 102 to present the mutual verification result 178 in a manner consistent with native telephony calls, application-based calls, carrier calls, enterprise calls, Voice over Internet Protocol calls, satellite calls, or other voice calls.

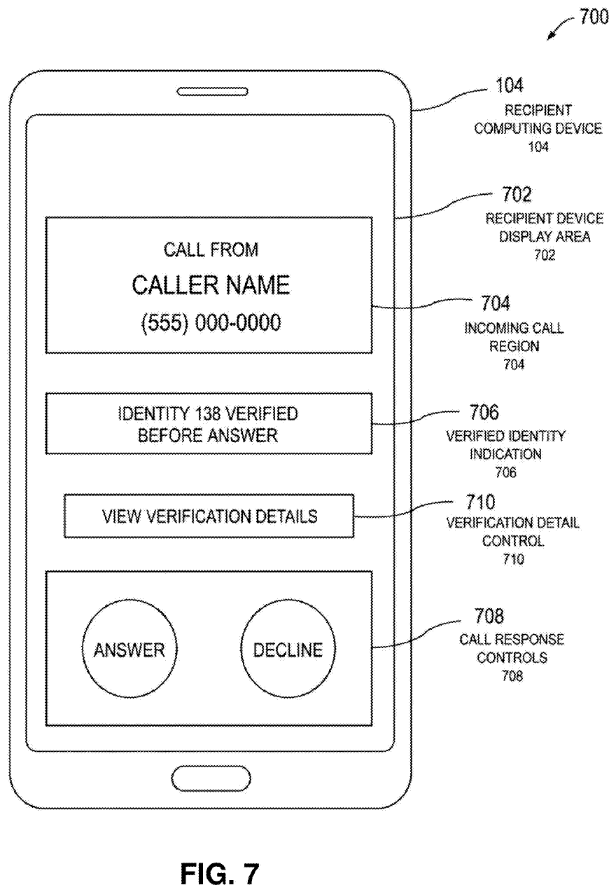

FIG. 7 illustrates an example recipient user interface 700 of the recipient computing device 104 displaying the indication 148 that the identity 138 of the caller is verified before the voice call is answered, according to one or more embodiments of the present invention. The recipient user interface 700 may appear on the recipient display 132 when the recipient computing device 104 receives the incoming voice call over the voice transport channel 110 and receives the verification payload 144 over the verification data channel 112.

The recipient user interface 700 includes a recipient device display area 702. The recipient device display area 702 may correspond to the recipient display 132 of the recipient computing device 104. In some embodiments, the recipient device display area 702 forms part of a native incoming call interface of an operating system of the recipient computing device 104. In other embodiments, the recipient device display area 702 forms part of a communication application interface, an enterprise communication interface, a carrier call interface, a vehicle communication interface, a wearable device interface, or another user interface capable of presenting incoming call information and verification information.

The recipient user interface 700 includes an incoming call region 704. The incoming call region 704 presents information associated with the incoming voice call. The information associated with the incoming voice call may include the identity 138 of the caller, a caller name, a caller telephone number, a contact name, an enterprise name, a device name, an account identifier, an image, an avatar, a role, an organization, a call type, or a combination thereof. The recipient computing device 104 may obtain the information associated with the incoming voice call from call setup information, a local contact record, the identity directory server 106, an enterprise directory, a carrier directory, a decentralized identity record, or another source.

The recipient user interface 700 includes a verified identity indication 706. The verified identity indication 706 represents an example of the indication 148 when the verification result 146 indicates successful verification. In some embodiments, the recipient computing device 104 displays the verified identity indication 706 when the recipient computing device 104 verifies the digital signature 142 using the public verification key 136 and determines that the verification payload 144 satisfies one or more verification policies. The one or more verification policies may include a timestamp recency policy, a nonce validation policy, a call correlation policy, a key status policy, a revocation status policy, a key pinning policy, a device attestation policy, an identity assurance policy, or a combination thereof.

The verified identity indication 706 may include text, an icon, a badge, a banner, a shield symbol, a check symbol, a notification, an overlay, a native call interface element, an application interface element, a sound, a haptic output, a color coded element, or another user interface element indicating that the identity 138 of the caller has been verified. In one example, the verified identity indication 706 includes text indicating that the caller identity has been verified. In another example, the verified identity indication 706 includes an icon or badge adjacent to the caller name in the incoming call region 704. In another example, the verified identity indication 706 appears as a high priority notification over a native incoming call interface.

In some embodiments, the recipient computing device 104 displays the verified identity indication 706 before the user of the recipient computing device 104 answers the incoming voice call. The recipient computing device 104 may display the verified identity indication 706 after the recipient computing device 104 receives the verification payload 144, obtains the public verification key 136, verifies the digital signature 142, and generates the verification result 146. In some embodiments, the recipient computing device 104 displays the verified identity indication 706 while the incoming voice call rings. In other embodiments, the recipient computing device 104 displays the verified identity indication 706 during call setup, before audio communication begins, or during an early stage of the voice call.

The recipient user interface 700 includes one or more call response controls 708 The one or more call response controls 708 may include an answer control, a decline control, a message reply control, a remind later control, a send to voicemail control, a block control, a report control, or another control associated with responding to the incoming voice call. In some embodiments, the recipient computing device 104 enables, disables, highlights, suppresses, reorders, or modifies one or more of the call response controls 708 based on the verification result 146.

In some embodiments, the recipient user interface 700 includes a verification detail control 710. The verification detail control 710 allows the user of the recipient computing device 104 to view additional information associated with the verification result 146. The additional information may include an identity assurance level, an algorithm identifier, a public key identifier, a key status, a timestamp validation status, a nonce validation status, a call correlation status, a device attestation status, a revocation status, a directory lookup status, a local cache status, or a combination thereof. The recipient computing device 104 may present the additional information in response to user selection of the verification detail control 710.

In some embodiments, the verified identity indication 706 reflects different assurance levels. For example, the recipient computing device 104 may display a first verified indication when the digital signature 142 verifies using the public verification key 136. The recipient computing device 104 may display a second verified indication when the digital signature 142 verifies and the timestamp 164 satisfies the predetermined recency window. The recipient computing device 104 may display a third verified indication when the digital signature 142 verifies, the timestamp 164 satisfies the predetermined recency window, and device attestation data associated with the caller computing device 102 satisfies a device attestation policy.

In some embodiments, the recipient computing device 104 displays the verified identity indication 706 as an overlay on or adjacent to the native incoming call interface. In such embodiments, the voice call may arrive through a native telephony system of the recipient computing device 104, while the verification payload 144 arrives through a push notification channel or another verification data channel 112. The recipient computing device 104 may use operating system notification functions, call identification functions, call directory functions, accessibility functions, telecom framework functions, carrier application functions, or other permitted interface functions to present the verified identity indication 706 in connection with the native incoming call interface.

In other embodiments, the recipient computing device 104 displays the verified identity indication 706 within a communication application interface. For example, when the voice call uses a Voice over Internet Protocol service, an enterprise communication service, a satellite communication service, or another application based voice service, the communication application may include the verified identity indication 706 directly within the incoming call screen. In further embodiments, a carrier system, an operating system service, or an enterprise communication system may provide the verified identity indication 706 within a controlled call display interface.

In one example, the caller computing device 102 initiates a standard cellular call to a telephone number associated with the recipient computing device 104. The caller computing device 102 transmits the verification payload 144 over a push notification channel that serves as the verification data channel 112. The recipient computing device 104 receives the incoming cellular call through a native telephony interface and receives the verification payload 144 through the push notification channel. The recipient computing device 104 obtains the public verification key 136 from the identity directory server 106, verifies the digital signature 142 locally, generates the verification result 146, and displays the verified identity indication 706 before the user answers the incoming cellular call.

In another example, the caller computing device 102 initiates a Voice over Internet Protocol call to the recipient computing device 104. The caller computing device 102 transmits the verification payload 144 through a signaling channel or a data channel associated with the Voice over Internet Protocol call. The recipient computing device 104 verifies the digital signature 142 locally and displays the verified identity indication 706 within an incoming call interface of the Voice over Internet Protocol application before the user accepts the Voice over Internet Protocol call.

In another example, the caller computing device 102 initiates an enterprise voice call to the recipient computing device 104. The recipient computing device 104 obtains the public verification key 136 from an enterprise identity provider, an identity directory server 106 associated with the enterprise, or a local cache. The recipient computing device 104 verifies the digital signature 142 locally and displays the verified identity indication 706 with an enterprise assurance level before the user answers the enterprise voice call.

The recipient user interface 700 allows the user of the recipient computing device 104 to view a cryptographic verification status before deciding whether to answer the incoming voice call. By presenting the verified identity indication 706 before the voice call is answered, the recipient computing device 104 can reduce reliance on caller identification information alone, voice recognition alone, network level attestation alone, or server determined authentication alone.

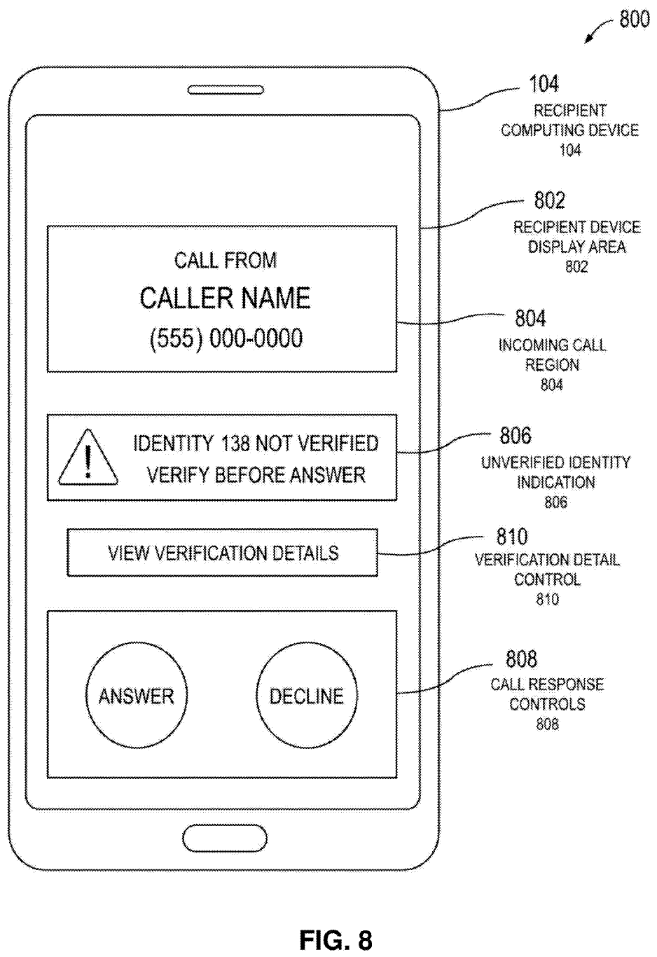

FIG. 8 illustrates an example recipient warning user interface 800 of the recipient computing device 104 displaying the indication 148 that the identity 138 of the caller is not verified before the voice call is answered, according to one or more embodiments of the present invention. The recipient warning user interface 800 may appear on the recipient display 132 when the recipient computing device 104 receives the incoming voice call over the voice transport channel 110 and fails to verify the verification payload 144 received over the verification data channel 112.

The recipient warning user interface 800 includes a recipient device display area 802. The recipient device display area 802 may correspond to the recipient display 132 of the recipient computing device 104. In some embodiments, the recipient device display area 802 forms part of a native incoming call interface of an operating system of the recipient computing device 104. In other embodiments, the recipient device display area 802 forms part of a communication application interface, an enterprise communication interface, a carrier call interface, a vehicle communication interface, a wearable device interface, or another user interface capable of presenting incoming call information and verification information.

The recipient warning user interface 800 includes an incoming call region 804. The incoming call region 804 presents information associated with the incoming voice call. The information associated with the incoming voice call may include a displayed caller name, a displayed caller telephone number, a contact name, an enterprise name, a device name, an account identifier, an image, an avatar, a role, an organization, a call type, or a combination thereof. In some circumstances, the displayed caller name or the displayed caller telephone number may originate from call setup information, a local contact record, a carrier service, an enterprise directory, a communication application, or another source and may not by itself establish that the identity 138 of the caller has been verified.

The recipient warning user interface 800 includes an unverified identity indication 806. The unverified identity indication 806 represents an example of the indication 148 when the verification result 146 indicates unsuccessful verification. In some embodiments, the recipient computing device 104 displays the unverified identity indication 806 when the recipient computing device 104 fails to verify the digital signature 142 using the public verification key 136 or determines that the verification payload 144 fails one or more verification policies. The one or more verification policies may include a timestamp recency policy, a nonce validation policy, a call correlation policy, a key status policy, a revocation status policy, a key pinning policy, a device attestation policy, an identity assurance policy, or a combination thereof.

The recipient computing device 104 may display the unverified identity indication 806 in response to different failure conditions. In some embodiments, the recipient computing device 104 displays the unverified identity indication 806 when the digital signature 142 does not verify using the public verification key 136. In some embodiments, the recipient computing device 104 displays the unverified identity indication 806 when the recipient computing device 104 cannot obtain the public verification key 136 associated with the identity 138 of the caller. In some embodiments, the recipient computing device 104 displays the unverified identity indication 806 when the timestamp 164 falls outside a predetermined recency window, when the nonce 166 has previously appeared, when the call identifier 162 fails to correlate with the incoming voice call, when the public verification key 136 has a revoked status, or when a subsequently obtained public verification key differs from a pinned public verification key stored by the recipient computing device 104.

The unverified identity indication 806 may include text, an icon, a badge, a banner, an alert, a warning symbol, a notification, an overlay, a native call interface element, an application interface element, a sound, a haptic output, a color coded element, or another user interface element indicating that the identity 138 of the caller has not been verified. In one example, the unverified identity indication 806 includes text indicating that the caller identity could not be verified. In another example, the unverified identity indication 806 includes a warning icon adjacent to the displayed caller name in the incoming call region 804. In another example, the unverified identity indication 806 appears as a high priority notification over a native incoming call interface.

In some embodiments, the recipient computing device 104 displays the unverified identity indication 806 before the user of the recipient computing device 104 answers the incoming voice call. The recipient computing device 104 may display the unverified identity indication 806 after the recipient computing device 104 receives the verification payload 144, attempts to obtain the public verification key 136, attempts to verify the digital signature 142, and generates the verification result 146. In some embodiments, the recipient computing device 104 displays the unverified identity indication 806 while the incoming voice call rings. In other embodiments, the recipient computing device 104 displays the unverified identity indication 806 during call setup, before audio communication begins, or during an early stage of the voice call.

The recipient warning user interface 800 includes one or more call response controls 808. The one or more call response controls 808 may include an answer control, a decline control, a message reply control, a remind later control, a send to voicemail control, a block control, a report control, or another control associated with responding to the incoming voice call. In some embodiments, the recipient computing device 104 enables, disables, highlights, suppresses, reorders, or modifies one or more of the call response controls 808 based on the verification result 146. For example, the recipient computing device 104 may highlight a decline control or a report control when the verification result 146 indicates unsuccessful verification.

In some embodiments, the recipient warning user interface 800 includes a verification detail control 810. The verification detail control 810 allows the user of the recipient computing device 104 to view additional information associated with the unsuccessful verification. The additional information may include a signature verification status, a public key retrieval status, a key status, a revocation status, a key pinning status, a timestamp validation status, a nonce validation status, a call correlation status, a device attestation status, an identity assurance level, or a combination thereof. The recipient computing device 104 may present the additional information in response to user selection of the verification detail control 810.

In some embodiments, the recipient warning user interface 800 displays different warning levels. For example, the recipient computing device 104 may display a first warning level when the recipient computing device 104 cannot obtain the public verification key 136 because of temporary network unavailability. The recipient computing device 104 may display a second warning level when the digital signature 142 fails to verify using the public verification key 136. The recipient computing device 104 may display a third warning level when the public verification key 136 has a revoked status, when the timestamp 164 falls outside the predetermined recency window, or when a key pinning mismatch suggests an unexpected public key change.

In some embodiments, the recipient computing device 104 displays the unverified identity indication 806 as an overlay on or adjacent to a native incoming call interface. In such embodiments, the voice call may arrive through a native telephony system of the recipient computing device 104, while the verification payload 144 arrives through a push notification channel or another verification data channel 112. The recipient computing device 104 may use operating system notification functions, call identification functions, call directory functions, accessibility functions, telecom framework functions, carrier application functions, or other permitted interface functions to present the unverified identity indication 806 in connection with the native incoming call interface.

In other embodiments, the recipient computing device 104 displays the unverified identity indication 806 within a communication application interface. For example, when the voice call uses a Voice over Internet Protocol service, an enterprise communication service, a satellite communication service, or another application based voice service, the communication application may include the unverified identity indication 806 directly within the incoming call screen. In further embodiments, a carrier system, an operating system service, or an enterprise communication system may provide the unverified identity indication 806 within a controlled call display interface.

In one example, the caller computing device 102 initiates a standard cellular call to a telephone number associated with the recipient computing device 104, but the recipient computing device 104 does not receive a corresponding verification payload 144 within a predetermined time window. The recipient computing device 104 generates the verification result 146 indicating unsuccessful verification and displays the unverified identity indication 806 before the user answers the standard cellular call.

In another example, the recipient computing device 104 receives the verification payload 144, but the digital signature 142 cannot be verified using the public verification key 136 associated with the caller's identity 138. The recipient computing device 104 generates the verification result 146 indicating unsuccessful verification and displays the unverified identity indication 806 before the user answers the incoming voice call. This scenario may occur when a malicious actor attempts to spoof the displayed caller telephone number without possessing the device bound private signing key 124.

In another example, the recipient computing device 104 receives the verification payload 144 and verifies the digital signature 142, but the timestamp 164 falls outside the predetermined recency window. The recipient computing device 104 generates the verification result 146 indicating unsuccessful verification and displays the unverified identity indication 806 before the user answers the incoming voice call. This scenario may indicate replay of a previously captured verification payload.

In another example, the recipient computing device 104 obtains the public verification key 136 from the identity directory server 106 and determines that the public verification key 136 differs from a pinned public verification key previously stored by the recipient computing device 104 for the identity 138 of the caller. The recipient computing device 104 may generate the verification result 146 indicating unsuccessful verification, display the unverified identity indication 806, display a key change warning, request additional authentication, or a combination thereof.

The recipient warning user interface 800 allows the user of the recipient computing device 104 to view a warning before deciding whether to answer the incoming voice call. By presenting the unverified identity indication 806 before the voice call is answered, the recipient computing device 104 can alert the user to a possible spoofing attempt, replay attempt, key mismatch, revoked key, missing verification payload, or other verification failure while still allowing the user or a policy engine to decide how to handle the incoming voice call.

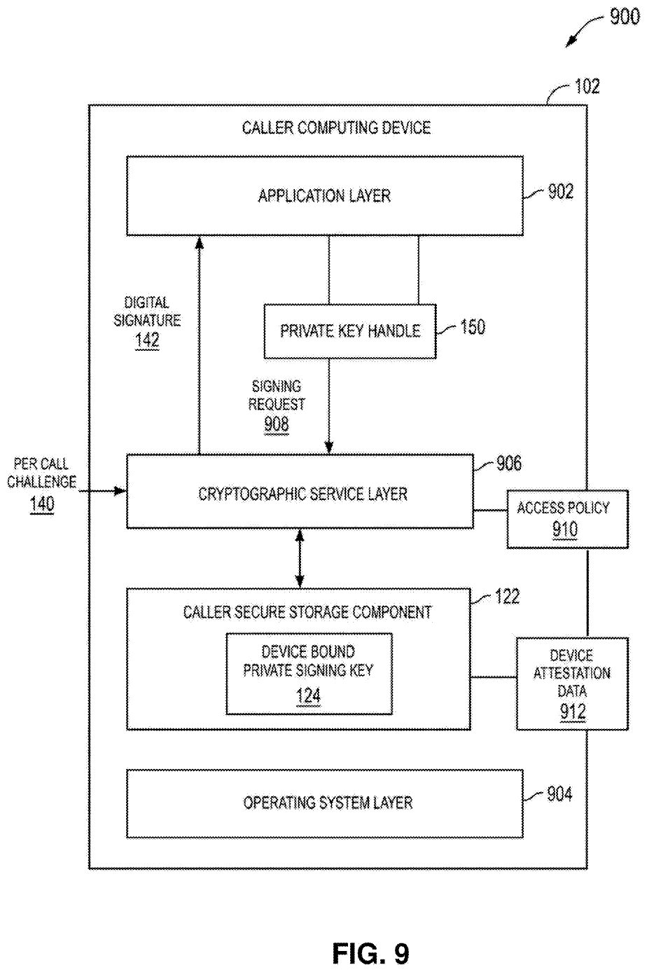

FIG. 9 illustrates an example secure key architecture 900 in which the caller secure storage component 122 protects the device bound private signing key 124 and enables the caller computing device 102 to produce the digital signature 142 without exporting plaintext private key material, according to one or more embodiments of the present invention. Although FIG. 9 describes the secure key architecture 900 with respect to the caller computing device 102, the recipient computing device 104 may include the same or similar secure key architecture 900 for protecting the recipient device bound private signing key 172.

The secure key architecture 900 includes an application layer 902, an operating system layer 904, a cryptographic service layer 906, and the caller secure storage component 122. The application layer 902 may include a caller identity verification application, a native telephony application, an enterprise communication application, a carrier application, a Voice over Internet Protocol application, a satellite communication application, or another application that initiates or participates in the voice call. The operating system layer 904 may include one or more operating system services that manage telephony functions, notification functions, key access policies, user authentication functions, or communication permissions. The cryptographic service layer 906 may include a cryptographic library, an operating system cryptographic framework, a keystore service, a security daemon, a trusted execution service, or another component that mediates cryptographic operations.

The caller secure storage component 122 protects the device bound private signing key 124. The caller secure storage component 122 may include a secure enclave, a hardware security module, a trusted execution environment, a hardware backed keystore, a StrongBox keystore, a secure element, a trusted platform module, or another secure component that protects cryptographic key material. In some embodiments, the caller secure storage component 122 stores the device bound private signing key 124 in a manner that prevents export of plaintext private key material corresponding to the device bound private signing key 124. In other embodiments, the caller secure storage component 122 stores a wrapping key, sealing key, access control key, or other protection key that encrypts or controls use of the device bound private signing key 124.

The secure key architecture 900 includes the private key handle 150. The private key handle 150 identifies the device bound private signing key 124 for permitted cryptographic operations without exposing plaintext private key material to the application layer 902. The private key handle 150 may include a key alias, a keystore identifier, a secure element reference, a cryptographic object reference, a hardware security module object identifier, a trusted execution environment reference, a pointer to a protected key object, or another reference that allows an authorized component to request use of the device bound private signing key 124.

During an example signing operation, the application layer 902 generates or obtains the per call challenge 140 associated with the particular instance of the voice call. The application layer 902 sends a signing request 908 to the cryptographic service layer 906. The signing request 908 may include the per call challenge 140, a hash of the per call challenge 140, the private key handle 150, an algorithm identifier, an access control parameter, a user authentication requirement, a device attestation request, or a combination thereof. In some embodiments, the signing request 908 does not include plaintext private key material corresponding to the device bound private signing key 124.

The cryptographic service layer 906 evaluates whether the signing request 908 satisfies an access policy 910. The access policy 910 may require that the caller computing device 102 remain unlocked, that a user perform biometric authentication, that a user enter a passcode, that a user demonstrate presence, that an enterprise policy permits use of the device bound private signing key 124, that a time based policy permits use, that an application identifier matches an authorized application, that a device integrity check succeeds, or that another policy condition has been satisfied. When the signing request 908 fails the access policy 910, the cryptographic service layer 906 may deny the signing request 908 and prevent production of the digital signature 142.

When the signing request 908 satisfies the access policy 910, the cryptographic service layer 906 requests a signing operation from the caller secure storage component 122. In some embodiments, the caller secure storage component 122 performs the signing operation internally using the device bound private signing key 124 and returns the digital signature 142. In other embodiments, the caller secure storage component 122 releases or uses an internal protection key only within an authorized protection boundary so that protected private key material can perform the signing operation without making plaintext private key material exportable to the application layer 902, the operating system layer 904, the identity directory server 106, the verification routing server 108, or another external component.

In some embodiments, the caller secure storage component 122 produces the digital signature 142 over the per call challenge 140. In other embodiments, the cryptographic service layer 906 hashes or canonicalizes the per call challenge 140 and the caller secure storage component 122 produces the digital signature 142 over the resulting hash or canonical representation. The canonical representation may include a deterministic encoding of the call identifier 162, the timestamp 164, the nonce 166, the identity 138, the recipient identity 160, an algorithm identifier, a public key identifier, contextual metadata, or a combination thereof.

The caller secure storage component 122 or the cryptographic service layer 906 returns the digital signature 142 to the application layer 902. The application layer 902 includes the digital signature 142 and the per call challenge 140 in the verification payload 144. The application layer 902 may also include the algorithm identifier, the public key identifier, device attestation data, certificate data, routing metadata, or a combination thereof in the verification payload 144. The caller computing device 102 then transmits the verification payload 144 over the verification data channel 112, as described with respect to FIG. 3.

In some embodiments, the secure key architecture 900 supports a post quantum digital signature algorithm. For example, the device bound private signing key 124 may correspond to an ML DSA key, an SLH DSA key, a Falcon key, or another post quantum signing key. In other embodiments, the secure key architecture 900 supports a classical public key digital signature algorithm, such as ECDSA, EdDSA, RSA PSS, or another classical signing algorithm. In further embodiments, the secure key architecture 900 supports a hybrid signature scheme in which the caller computing device 102 produces a post quantum digital signature and a classical public key digital signature for the same per call challenge 140 or for related challenge data.

In some embodiments, the caller secure storage component 122 natively performs the signature algorithm used to produce the digital signature 142. In other embodiments, the caller secure storage component 122 protects a wrapping key or an authorization key while the cryptographic service layer 906 performs at least part of the signature algorithm. For example, when a hardware component does not natively support a particular post quantum digital signature algorithm, the caller secure storage component 122 may protect an encryption key that encrypts the device bound private signing key 124, may require local user authentication before decryption, and may cause plaintext private key material to exist only within a controlled memory region for a limited time during signing. The caller computing device 102 may clear the controlled memory region after the signing operation.

In some embodiments, the secure key architecture 900 generates the public verification key 136 corresponding to the device bound private signing key 124. The caller computing device 102 may export the public verification key 136 because the public verification key 136 does not constitute secret key material. The caller computing device 102 may include the public verification key 136 in the registration payload 152 or may provide the public verification key 136 to the identity directory server 106 through another registration process. The identity directory server 106 may store the public verification key 136 in association with the identity 138, as described with respect to FIG. 2.

In some embodiments, the secure key architecture 900 provides device attestation data 912. The device attestation data 912 may indicate that the caller computing device 102 generated or protected the device bound private signing key 124 using the caller secure storage component 122, that the caller computing device 102 satisfies a device integrity policy, that a key use policy applies to the device bound private signing key 124, or that a particular hardware or software security property exists. The caller computing device 102 may include the device attestation data 912 in the registration payload 152, the verification payload 144, or both.

In some embodiments, the secure key architecture 900 enforces key use restrictions. The key use restrictions may permit the device bound private signing key 124 to sign only per call challenge data, to sign only data that includes the call identifier 162, to sign only data generated by an authorized application, to sign only after successful local user authentication, to sign only while the caller computing device 102 satisfies a device integrity policy, to sign only during a permitted time period, or to sign only for identities registered with the identity directory server 106. The caller secure storage component 122, the cryptographic service layer 906, the operating system layer 904, the application layer 902, or a combination thereof may enforce the key use restrictions.

In some embodiments, the secure key architecture 900 supports key rotation. For example, the caller computing device 102 may generate a replacement device bound private signing key and a replacement public verification key. The caller computing device 102 may produce a key transition record by signing the replacement public verification key using the device bound private signing key 124. The caller computing device 102 may transmit the key transition record to the identity directory server 106 so that other computing devices can verify continuity between the public verification key 136 and the replacement public verification key.

In some embodiments, the secure key architecture 900 supports key revocation and lost device recovery. For example, when the user loses the caller computing device 102, the identity directory server 106 may mark the public verification key 136 as revoked after receiving a recovery request that satisfies a recovery policy. The recovery policy may include a one time code, an account authentication factor, an enterprise administrator approval, a backup recovery code, an identity provider assertion, or a combination thereof. After revocation, the recipient computing device 104 may treat the public verification key 136 as invalid even if the digital signature 142 verifies.

In some embodiments, the secure key architecture 900 supports multi device identities. For example, the identity 138 may correspond to the public verification key 136 associated with the caller computing device 102 and another public verification key associated with another computing device of the same user. The identity directory server 106 may store each public verification key in association with the identity 138. A recipient computing device 104 may generate the verification result 146 by determining whether the digital signature 142 verifies against at least one valid public verification key associated with the identity 138.

The secure key architecture 900 reduces the risk that an attacker can impersonate the caller's identity 138 by copying or exporting plaintext private key material. The secure key architecture 900 also allows the caller computing device 102 to produce the digital signature 142 for the particular instance of the voice call while allowing the recipient computing device 104 to verify the digital signature 142 using the public verification key 136.

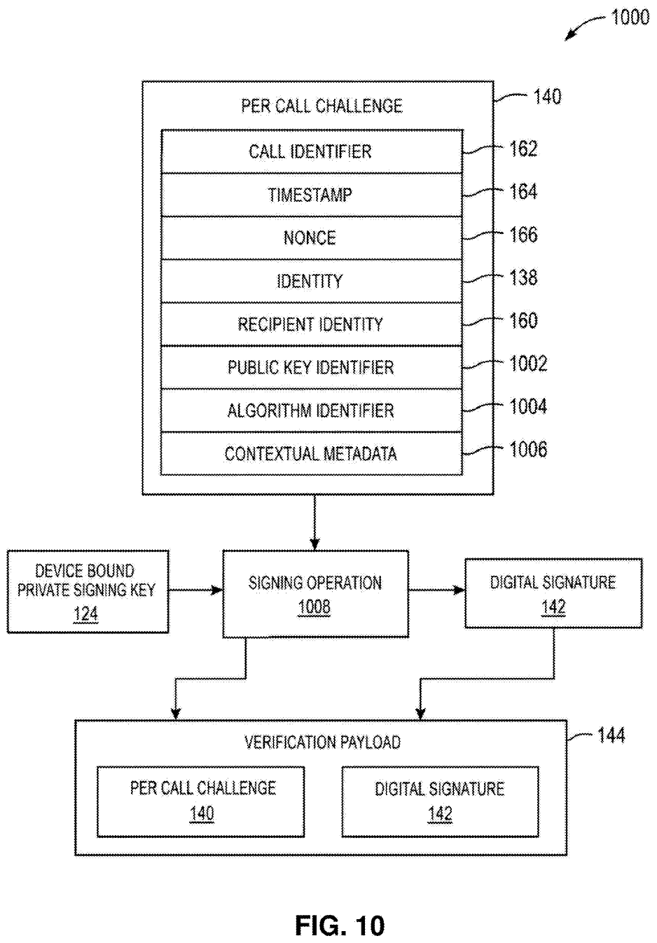

FIG. 10 illustrates an example challenge structure 1000 of the per call challenge 140, according to one or more embodiments of the present invention. The caller computing device 102 may generate the per-call challenge 140 during the call initiation process 300 described with respect to FIG. 3. The caller computing device 102 may produce the digital signature 142 over the per-call challenge 140 using the device-bound private signing key 124 before transmitting the verification payload 144 to the recipient computing device 104.

The challenge structure 1000 includes the call identifier 162. The call identifier 162 identifies the particular instance of the voice call. In some embodiments, the caller computing device 102 generates the call identifier 162 using a random value, a pseudorandom value, a universally unique identifier, a session identifier, a call setup identifier, a carrier call identifier, an application session identifier, an operating system call identifier, or another identifier associated with the particular instance of the voice call. The recipient computing device 104 may use the call identifier 162 to correlate the verification payload 144 with the incoming voice call.

The challenge structure 1000 includes the timestamp 164. The timestamp 164 indicates a time associated with the generation of the per-call challenge 140, the production of the digital signature 142, the transmission of the verification payload 144, or the initiation of the voice call. In some embodiments, the timestamp 164 includes a Unix timestamp, a network time value, a carrier time value, an operating system time value, a secure hardware time value, or another time value. The timestamp 164 may include second precision, sub second precision, or another precision level suitable for determining whether the verification payload 144 remains fresh.

The challenge structure 1000 includes the nonce 166. The nonce 166 includes a random or pseudorandom value generated for the particular instance of the voice call. In some embodiments, the caller computing device 102 generates the nonce 166 using a cryptographic random number generator. The nonce 166 may include at least 64 bits, at least 96 bits, at least 128 bits, at least 192 bits, at least 256 bits, or another amount of entropy suitable for reducing reuse of the per call challenge 140. The recipient computing device 104 may use the nonce 166 to detect replay or reuse of the verification payload 144.

In some embodiments, the challenge structure 1000 includes the identity 138 of the caller. The identity 138 may include a telephone number, a subscriber identity module identifier, a device identifier, an operating system identity, an enterprise identity, a decentralized identifier, a carrier issued identity, a government issued identity, or another identity anchor associated with the caller. Including the identity 138 in the per call challenge 140 can bind the digital signature 142 to the identity 138 that the recipient computing device 104 uses to obtain the public verification key 136.

In some embodiments, the challenge structure 1000 includes the recipient identity 160. The recipient identity 160 may include a telephone number, a contact identifier, a subscriber identity module identifier, a device identifier, an operating system identity, an enterprise identity, a decentralized identifier, a carrier issued identity, a government issued identity, or another identity anchor associated with the recipient computing device 104 or a user of the recipient computing device 104. Including the recipient identity 160 in the per call challenge 140 can reduce reuse of the verification payload 144 for a different recipient.

In some embodiments, the challenge structure 1000 includes a public key identifier 1002. The public key identifier 1002 identifies the public verification key 136 or a directory record associated with the public verification key 136. The recipient computing device 104 may use the public key identifier 1002 to obtain the public verification key 136 from the identity directory server 106, a local cache, a pinned public key record, a certificate, a distributed ledger, an enterprise identity provider, a carrier identity system, or another trusted source.

In some embodiments, the challenge structure 1000 includes an algorithm identifier 1004. The algorithm identifier 1004 identifies a digital signature algorithm or a verification operation associated with the digital signature 142. For example, the algorithm identifier 1004 may identify ML DSA, SLH DSA, Falcon, ECDSA, EdDSA, RSA PSS, a hybrid signature scheme, or another suitable asymmetric digital signature algorithm. The recipient computing device 104 may use the algorithm identifier 1004 to select a verification operation for verifying the digital signature 142.

In some embodiments, the challenge structure 1000 includes contextual metadata 1006. The contextual metadata 1006 may include device information, session information, call setup information, routing information, carrier information, network information, enterprise policy information, device attestation information, application version information, user authentication status information, location consistency information, risk information, or another value associated with the particular instance of the voice call. The recipient computing device 104 may evaluate the contextual metadata 1006 as part of a verification policy.

In some embodiments, the caller computing device 102 forms the per call challenge 140 as a structured data object. The structured data object may include a JSON object, a CBOR object, a protocol buffer message, a type length value structure, a token, a certificate extension, a call signaling field, a binary encoded message, or another machine readable format. In some embodiments, the caller computing device 102 canonicalizes the structured data object before producing the digital signature 142 so that the recipient computing device 104 can reproduce the same signed data during verification.

In one example, the per call challenge 140 includes the call identifier 162, the timestamp 164, the nonce 166, the identity 138, the recipient identity 160, the public key identifier 1002, and the algorithm identifier 1004. The caller computing device 102 signs this combination of values using the device bound private signing key 124. The recipient computing device 104 verifies the digital signature 142 over the same combination of values using the public verification key 136.

In another example, the per call challenge 140 includes the call identifier 162, the timestamp 164, and the nonce 166, and the verification payload 144 separately includes the identity 138, the recipient identity 160, the public key identifier 1002, and the algorithm identifier 1004. In such an example, the recipient computing device 104 may verify the digital signature 142 over the per call challenge 140 and may evaluate the additional values in the verification payload 144 as part of a call correlation policy, a key lookup policy, or another verification policy.

In some embodiments, the recipient computing device 104 validates the call identifier 162 by determining whether the call identifier 162 correlates with the incoming voice call. The recipient computing device 104 may compare the call identifier 162 with call setup information, timing information, routing metadata, a push notification identifier, a signaling session identifier, a native telephony identifier, or another call related value. The recipient computing device 104 may treat the verification payload 144 as not verified when the call identifier 162 does not correlate with the incoming voice call.

In some embodiments, the recipient computing device 104 validates the timestamp 164 by comparing the timestamp 164 with a current time at the recipient computing device 104. The recipient computing device 104 may reject the verification payload 144 when the timestamp 164 falls outside a predetermined recency window. The predetermined recency window may include 15 seconds, 30 seconds, 60 seconds, 120 seconds, 300 seconds, or another time period selected based on network latency, call setup latency, device settings, enterprise policy, carrier policy, or user settings.

In some embodiments, the recipient computing device 104 validates the nonce 166 by checking whether the nonce 166 has previously appeared in association with the identity 138, the public verification key 136, the call identifier 162, the recipient identity 160, or another value. The recipient computing device 104 may store recently received nonce values in a local replay cache. The recipient computing device 104 may treat the verification payload 144 as not verified when the nonce 166 matches a previously received nonce value within a replay detection window.

In some embodiments, the recipient computing device 104 validates the identity 138 and the recipient identity 160. For example, the recipient computing device 104 may determine whether the identity 138 corresponds to the displayed caller telephone number or another displayed caller identifier in the incoming call region 704 or the incoming call region 804. The recipient computing device 104 may also determine whether the recipient identity 160 corresponds to the recipient computing device 104, a user account on the recipient computing device 104, or a telephone number receiving the incoming voice call.

In some embodiments, the recipient computing device 104 validates the public key identifier 1002 and the algorithm identifier 1004. For example, the recipient computing device 104 may determine whether the public key identifier 1002 corresponds to an active public verification key associated with the identity 138. The recipient computing device 104 may also determine whether the algorithm identifier 1004 corresponds to an algorithm permitted by a local policy, an enterprise policy, a carrier policy, or a system policy. The recipient computing device 104 may reject the verification payload 144 when the algorithm identifier 1004 identifies a disallowed algorithm.

In some embodiments, the recipient computing device 104 validates the contextual metadata 1006. For example, the recipient computing device 104 may determine whether device attestation information indicates that the caller computing device 102 protects the device-bound private signing key 124 using the caller secure storage component 122. As another example, the recipient computing device 104 may determine whether location consistency information, carrier information, enterprise policy information, or risk information satisfies a verification policy.

In some embodiments, the caller computing device 102 includes a hash of one or more values in the per call challenge 140 instead of including each value directly. For example, the per call challenge 140 may include a hash of call setup information, a hash of the recipient identity 160, a hash of contextual metadata 1006, or a hash of a canonical data object. The recipient computing device 104 may compute a corresponding hash and may verify the digital signature 142 over the hash or over a signed object that includes the hash.

In some embodiments, the challenge structure 1000 supports privacy preserving operation. For example, the caller computing device 102 may include a pseudonymous identity value, a public key identifier 1002, a blinded identity value, or a hashed identity value rather than including a plaintext telephone number or other plaintext identity anchor in the per call challenge 140. The recipient computing device 104 may use the pseudonymous identity value, the public key identifier 1002, the blinded identity value, or the hashed identity value to obtain or select the public verification key 136 while reducing exposure of personal information in the verification payload 144.

In some embodiments, the challenge structure 1000 supports mutual verification. For example, the recipient per call challenge 168 may include the call identifier 162, a recipient timestamp, a recipient nonce, the identity 138, the recipient identity 160, the public key identifier 1002, the algorithm identifier 1004, contextual metadata 1006, or a combination thereof. The recipient computing device 104 may produce the recipient digital signature 170 over the recipient per call challenge 168 using the recipient device bound private signing key 172.

The challenge structure 1000 helps bind the digital signature 142 to the particular instance of the voice call. By including values such as the call identifier 162, the timestamp 164, and the nonce 166, the challenge structure 1000 reduces the likelihood that a captured verification payload 144 from one voice call can successfully verify for another voice call. By optionally including the identity 138, the recipient identity 160, the public key identifier 1002, the algorithm identifier 1004, and the contextual metadata 1006, the challenge structure 1000 can support additional verification policies, identity binding, key selection, algorithm selection, and assurance level determinations.

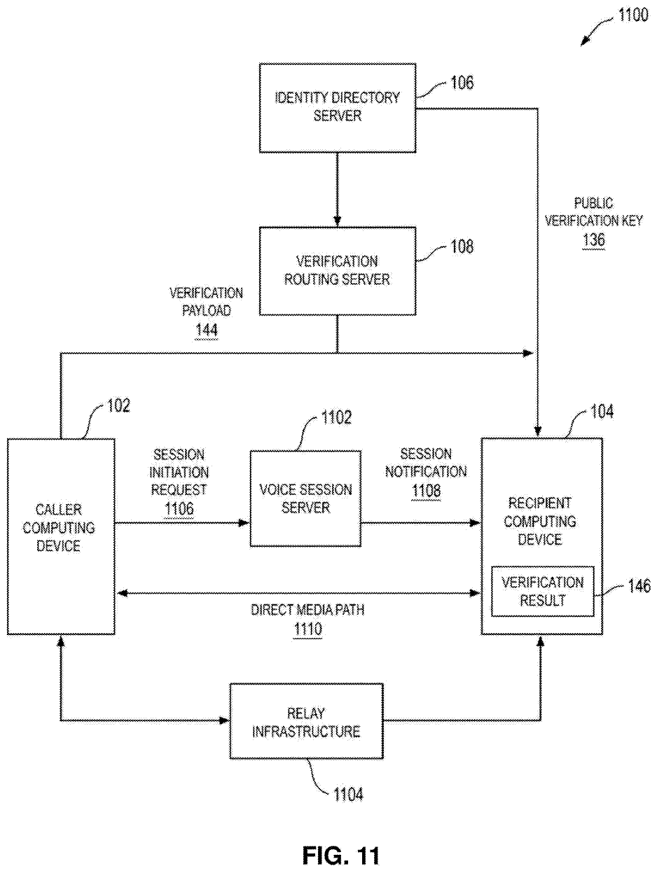

FIG. 11 illustrates an example voice session implementation 1100 in which a voice session server 1102 or relay infrastructure 1104 carries, establishes, assists, or relays a voice communication while the recipient computing device 104 performs signature verification using the public verification key 136, according to one or more embodiments of the present invention. The voice session implementation 1100 represents an alternative to an implementation in which the voice call proceeds through a native cellular or public switched telephone network channel. The recipient computing device 104 may still generate the verification result 146 locally, even when the voice session server 1102 or the relay infrastructure 1104 participates in voice session setup or audio transport.

The voice session implementation 1100 includes the caller computing device 102, the recipient computing device 104, the identity directory server 106, the verification routing server 108, the voice session server 1102, and the relay infrastructure 1104. In some embodiments, the voice session server 1102 establishes or coordinates a voice session between the caller computing device 102 and the recipient computing device 104. The voice session server 1102 may exchange call setup messages, session descriptions, codec information, network traversal information, device addresses, user account information, or other session establishment information.

In some embodiments, the relay infrastructure 1104 carries or relays audio content of the voice call when direct communication between the caller computing device 102 and the recipient computing device 104 cannot occur or when a system policy selects relay transport. The relay infrastructure 1104 may include a relay server, a media server, a traversal server, a session traversal utilities for network address translation server, a traversal using relays around network address translation server, a media gateway, a selective forwarding unit, or another component that assists with audio transport. In other embodiments, the caller computing device 102 and the recipient computing device 104 exchange audio directly after the voice session server 1102 establishes the voice session.

The voice session server 1102 and the relay infrastructure 1104 may form part of a Voice over Internet Protocol system, a WebRTC system, an enterprise communication system, a satellite communication system, a carrier voice service, a unified communications platform, or another voice communication system. In some embodiments, the voice session server 1102 and the verification routing server 108 operate as separate servers or services. In other embodiments, a common service provider operates the voice session server 1102, the relay infrastructure 1104, the verification routing server 108, the identity directory server 106, or a combination thereof.

During an example operation of the voice session implementation 1100, the caller computing device 102 generates the per call challenge 140 associated with the particular instance of the voice call and produces the digital signature 142 over the per call challenge 140 using the device bound private signing key 124. The caller computing device 102 may produce the digital signature 142 using a post quantum digital signature algorithm, a classical public key digital signature algorithm, or a hybrid signature scheme, as described herein.

The caller computing device 102 transmits the verification payload 144 toward the recipient computing device 104 over the verification data channel 112. In some embodiments, the verification routing server 108 routes the verification payload 144 to the recipient computing device 104. In other embodiments, the voice session server 1102 carries the verification payload 144 as part of session setup signaling, a data channel, a control message, or another signaling path associated with the voice session. The verification payload 144 includes the per call challenge 140 and the digital signature 142 and may include other data described herein.

The caller computing device 102 also initiates the voice call through the voice session server 1102. In some embodiments, the caller computing device 102 transmits a session initiation request 1106 to the voice session server 1102. The session initiation request 1106 may include the recipient identity 160, call setup information, session description information, codec information, network traversal information, authentication information, account information, routing information, or a combination thereof. The voice session server 1102 uses the session initiation request 1106 to establish or attempt to establish the voice session with the recipient computing device 104.

The voice session server 1102 transmits a session notification 1108 to the recipient computing device 104. The session notification 1108 may indicate that the caller computing device 102 seeks to establish the voice session with the recipient computing device 104. The session notification 1108 may include call setup information, session description information, codec information, routing information, a caller identifier, the identity 138, the recipient identity 160, or a combination thereof. In some embodiments, the session notification 1108 causes the recipient computing device 104 to display an incoming call interface.

The recipient computing device 104 receives the verification payload 144 and obtains the public verification key 136 associated with the identity 138 of the caller. In some embodiments, the recipient computing device 104 obtains the public verification key 136 from the identity directory server 106. In other embodiments, the recipient computing device 104 obtains the public verification key 136 from a local cache, a pinned public key record, a certificate, an enterprise identity provider, a carrier identity system, a decentralized identity system, a distributed ledger, or another trusted source.

The recipient computing device 104 verifies the digital signature 142 using the public verification key 136 to generate the verification result 146. In some embodiments, the recipient computing device 104 performs the verification locally and does not receive the verification result 146 from the voice session server 1102, the relay infrastructure 1104, the verification routing server 108, the identity directory server 106, or another server. The recipient computing device 104 may also validate the call identifier 162, the timestamp 164, the nonce 166, key status information, revocation information, device attestation information, session correlation information, or a combination thereof.

The recipient computing device 104 displays the indication 148 of the verification result 146 before the recipient computing device 104 accepts or answers the voice session. In some embodiments, the indication 148 appears within an incoming call screen of a Voice over Internet Protocol application or another communication application. In other embodiments, the indication 148 appears as an operating system notification, an overlay, a banner, a badge, a warning, an icon, a haptic output, a sound, or another interface element associated with the incoming voice session.

When the user accepts the voice session, the caller computing device 102 and the recipient computing device 104 exchange audio content through a direct media path 1110, through the relay infrastructure 1104, or through another voice transport path. In some embodiments, the direct media path 1110 carries audio directly between the caller computing device 102 and the recipient computing device 104. In other embodiments, the relay infrastructure 1104 carries audio content between the caller computing device 102 and the recipient computing device 104. The recipient computing device 104 may perform the verification operation before, during, or after establishment of the direct media path 1110 or the relay infrastructure 1104.

In some embodiments, the verification data channel 112 remains separate from the audio transport even when the voice session server 1102 participates in call setup. For example, the verification payload 144 may travel through the verification routing server 108 while audio content travels through the relay infrastructure 1104. In another example, the verification payload 144 may travel through a session data channel associated with the voice session while audio content travels through a media channel. In either example, the recipient computing device 104 may locally verify the digital signature 142 and generate the verification result 146 without a server determining the verification result 146.

In some embodiments, the voice session implementation 1100 supports mutual verification. The recipient computing device 104 may generate the recipient per call challenge 168 and produce the recipient digital signature 170 using the recipient device bound private signing key 172. The recipient computing device 104 may transmit the recipient verification payload 174 toward the caller computing device 102 through the verification routing server 108, the voice session server 1102, a session data channel, or another data channel. The caller computing device 102 may obtain the recipient public verification key 176 and locally verify the recipient digital signature 170 to generate the mutual verification result 178.

In some embodiments, the voice session implementation 1100 supports enterprise deployments. For example, the voice session server 1102 may include an enterprise communication server, and the identity directory server 106 may associate the public verification key 136 with an enterprise identity. The recipient computing device 104 may verify the digital signature 142 locally and may display the indication 148 with an enterprise assurance level before the recipient accepts the enterprise voice session.

In some embodiments, the voice session implementation 1100 supports carrier or service provider deployments. For example, the voice session server 1102 may operate within a carrier network, a mobile virtual network operator network, a satellite communication network, or a managed Voice over Internet Protocol service. The verification payload 144 may travel through a signaling channel, a control channel, a push notification channel, or another verification data channel 112. The recipient computing device 104 may still generate the verification result 146 locally using the public verification key 136.

In some embodiments, the voice session implementation 1100 supports fallback operation. For example, the caller computing device 102 may first attempt a direct media path 1110 and may use the relay infrastructure 1104 when direct media establishment fails. The caller computing device 102 may transmit the verification payload 144 before, during, or after a fallback to the relay infrastructure 1104. The recipient computing device 104 may correlate the verification payload 144 with the incoming voice session using the call identifier 162, the session initiation request 1106, the session notification 1108, timing information, routing information, or a combination thereof.

In some embodiments, the voice session implementation 1100 allows a service provider to carry or assist with audio while avoiding control over the verification result 146. For example, the voice session server 1102 may establish the voice session and the relay infrastructure 1104 may relay audio content, but the recipient computing device 104 may still verify the digital signature 142 locally. This arrangement can reduce reliance on a server supplied assertion of caller identity because the recipient computing device 104 evaluates the cryptographic proof associated with the particular instance of the voice call.

The voice session implementation 1100 allows the identity verification techniques described herein to operate in environments in which the voice call uses application based voice transport, managed voice transport, relayed media transport, or peer to peer media transport. The voice session implementation 1100 also preserves the ability of the recipient computing device 104 to generate the verification result 146 using the public verification key 136 and to display the indication 148 before the recipient accepts or answers the voice communication.

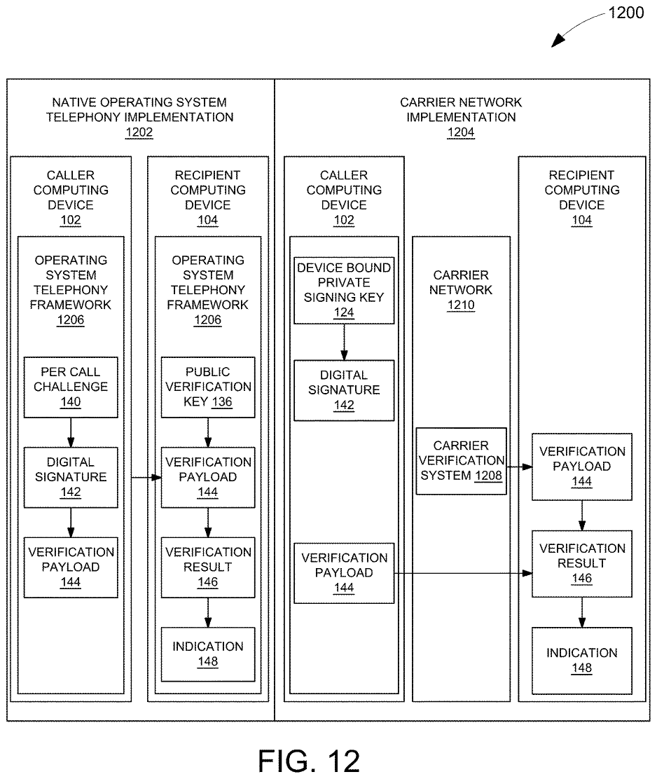

FIG. 12 illustrates example alternative implementations 1200, including a native operating system telephony implementation 1202 and a carrier network implementation 1204, according to one or more embodiments of the present invention. The alternative implementations 1200 show that the identity verification techniques described herein may operate within an application, an operating system, a carrier network, an enterprise communication system, or another communication environment while maintaining use of a device bound private signing key, a per call challenge, a digital signature, a public verification key, and a verification result presented before or during handling of a voice call.

The native operating system telephony implementation 1202 includes an operating system telephony framework 1206 executing on the caller computing device 102, the recipient computing device 104, or both. The operating system telephony framework 1206 may include a native dialer, a native incoming call interface, a call management service, a call directory service, a call identification service, a notification service, a cryptographic service, a secure key service, or another operating system component associated with voice calls. In some embodiments, the operating system telephony framework 1206 performs one or more operations that the application layer 902 performs in other embodiments.

In the native operating system telephony implementation 1202, the caller computing device 102 may generate the per call challenge 140 in response to a call initiation event detected by the operating system telephony framework 1206. The call initiation event may include selection of a contact in a native phone application, entry of a telephone number in a native dialer, selection of a call link, invocation of an emergency or enterprise call function, or another event that causes the caller computing device 102 to initiate the voice call. The caller computing device 102 produces the digital signature 142 over the per call challenge 140 using the device bound private signing key 124.

The operating system telephony framework 1206 may transmit the verification payload 144 over the verification data channel 112 and may initiate the voice call over the voice transport channel 110. In some embodiments, the operating system telephony framework 1206 sends the verification payload 144 through a push notification channel, a messaging channel, a packet data channel, a signaling channel, a carrier signaling channel, a WebRTC data channel, a SIP signaling channel, an RCS channel, or another verification data channel 112. The operating system telephony framework 1206 may initiate the voice call through a cellular voice service, a public switched telephone network service, a Voice over Internet Protocol service, a satellite voice service, or another voice transport service.

The recipient computing device 104 may receive the verification payload 144 through the operating system telephony framework 1206 and may obtain the public verification key 136 associated with the identity 138 of the caller. The recipient computing device 104 may obtain the public verification key 136 from the identity directory server 106, a local cache, a pinned public key record, a certificate, a distributed ledger, an enterprise identity provider, a carrier identity system, an operating system identity service, or another trusted source. The operating system telephony framework 1206 may cause the recipient computing device 104 to verify the digital signature 142 using the public verification key 136.

In some embodiments of the native operating system telephony implementation 1202, the recipient computing device 104 generates the verification result 146 locally without receiving the verification result 146 from the identity directory server 106, the verification routing server 108, a carrier server, or another server. The recipient computing device 104 may display the indication 148 of the verification result 146 within a native incoming call interface. For example, the native incoming call interface may display a verified identity badge, an unverified identity warning, a verification detail control, an assurance level, a key change warning, a call handling recommendation, or another user interface element associated with the verification result 146.

In some embodiments, the native operating system telephony implementation 1202 performs identity verification automatically for voice calls handled by the operating system telephony framework 1206. For example, the caller computing device 102 may automatically produce the digital signature 142 when the user places a call through a native dialer, and the recipient computing device 104 may automatically verify the digital signature 142 when the voice call arrives. In such embodiments, the user need not open a separate identity verification application to receive the indication 148.

In some embodiments, the native operating system telephony implementation 1202 supports local user authentication before signature production. For example, the operating system telephony framework 1206 may require device unlock status, biometric authentication, passcode authentication, user presence, or another local authorization condition before the caller computing device 102 produces the digital signature 142 using the device bound private signing key 124. The operating system telephony framework 1206 may enforce this requirement through a secure key service, a secure enclave, a hardware backed keystore, a trusted execution environment, or another caller secure storage component 122.

The carrier network implementation 1204 includes a carrier verification system 1208 associated with a carrier network 1210. The carrier network 1210 may include a mobile network operator network, a mobile virtual network operator network, a public switched telephone network provider, a Voice over Internet Protocol provider, a satellite voice provider, an enterprise telephony provider, or another voice service provider. The carrier verification system 1208 may include one or more carrier servers, signaling components, call setup components, authentication components, public key lookup components, routing components, or call display components.

In the carrier network implementation 1204, the caller computing device 102 still produces the digital signature 142 using the device bound private signing key 124. In some embodiments, the caller computing device 102 generates the per call challenge 140 in response to call setup signaling, a dial event, a carrier application event, a subscriber identity module event, an operating system telephony event, or another call initiation event. The caller computing device 102 may transmit the verification payload 144 to the carrier verification system 1208, to the recipient computing device 104, to the verification routing server 108, or to another component over the verification data channel 112.

The carrier verification system 1208 may route the verification payload 144 through the carrier network 1210 as part of call setup signaling, a supplementary service message, an internet protocol data message, a push notification message, an RCS message, a SIP message, a carrier application message, or another carrier supported data message. In some embodiments, the carrier verification system 1208 does not determine the verification result 146 and instead delivers the verification payload 144 to the recipient computing device 104 so that the recipient computing device 104 can verify the digital signature 142 locally. In other embodiments, the carrier verification system 1208 may provide delivery confirmation, routing information, call correlation information, or identity directory access without determining the verification result 146.

The recipient computing device 104 may obtain the public verification key 136 from the identity directory server 106, the carrier verification system 1208, a carrier identity directory, a local cache, a pinned public key record, a certificate, a distributed ledger, or another trusted source. The recipient computing device 104 verifies the digital signature 142 using the public verification key 136 and generates the verification result 146. In some embodiments, the recipient computing device 104 generates the verification result 146 locally without receiving the verification result 146 from the carrier verification system 1208.

In some embodiments of the carrier network implementation 1204, the recipient computing device 104 displays the indication 148 through a carrier controlled call display interface, a native incoming call interface, a carrier application interface, a messaging interface, an enterprise call interface, or another interface. The indication 148 may include a verified identity indication, an unverified identity indication, an assurance level, a key status indication, a revocation warning, a key change warning, or another user interface element associated with the verification result 146.

In some embodiments, the carrier verification system 1208 integrates identity verification into call setup while preserving device control of signing. For example, the carrier verification system 1208 may request or receive the verification payload 144 during call setup, but the device bound private signing key 124 remains protected by the caller secure storage component 122 of the caller computing device 102. The carrier verification system 1208 need not possess, export, or access plaintext private key material corresponding to the device bound private signing key 124.

In some embodiments, the carrier network implementation 1204 supports subscriber identity module swap detection. For example, when an incoming voice call displays a telephone number associated with the identity 138 but the recipient computing device 104 does not receive a verification payload 144 that verifies using the public verification key 136 associated with the identity 138, the recipient computing device 104 may display an unverified identity warning. In another example, when the carrier verification system 1208 detects that a subscriber identity module associated with the identity 138 has changed, the carrier verification system 1208 may provide subscriber identity module status information to the recipient computing device 104, and the recipient computing device 104 may use the subscriber identity module status information as an additional factor when generating the verification result 146.

In some embodiments, the carrier network implementation 1204 supports carrier issued identities. For example, the identity directory server 106 or a carrier identity directory may associate the public verification key 136 with a carrier issued identity, a telephone number, an international mobile subscriber identity, an integrated circuit card identifier, an account identifier, or another carrier related identity anchor. The recipient computing device 104 may use the associated identity anchor to obtain the public verification key 136 and verify the digital signature 142.

In some embodiments, the alternative implementations 1200 support enterprise deployments. For example, an enterprise communication system may perform functions similar to the operating system telephony framework 1206 or the carrier verification system 1208. The identity directory server 106 may associate the public verification key 136 with an enterprise identity or a government issued identity. The recipient computing device 104 may verify the digital signature 142 locally and display the indication 148 with an enterprise assurance level before answering the voice call.

In some embodiments, the alternative implementations 1200 support offline or limited connectivity operation. For example, the recipient computing device 104 may obtain the public verification key 136 from a local cache or a pinned public key record when the recipient computing device 104 cannot reach the identity directory server 106 at call time. The recipient computing device 104 may apply a local validity policy before using the cached public verification key. The local validity policy may consider a cache age, a prior revocation status, an identity assurance level, a prior successful verification, a carrier status value, an enterprise policy, or a combination thereof.

In some embodiments, the alternative implementations 1200 support different levels of server participation. In one embodiment, the recipient computing device 104 performs the verification operation locally and no server determines the verification result 146. In another embodiment, a trusted server, a carrier server, an enterprise server, a secure execution environment, or a distributed verification service may assist with one or more verification operations while the recipient computing device 104 displays the indication 148. In such embodiments, the caller computing device 102 may still produce the digital signature 142 using the device bound private signing key 124, and the verification payload 144 may still correspond to the particular instance of the voice call.

In some embodiments, the alternative implementations 1200 support mutual verification. For example, the recipient computing device 104 may generate the recipient per call challenge 168 and produce the recipient digital signature 170 using the recipient device bound private signing key 172. The recipient computing device 104 may transmit the recipient verification payload 174 through the operating system telephony framework 1206, the carrier verification system 1208, the verification routing server 108, a signaling channel, a push notification channel, or another verification data channel 112. The caller computing device 102 may verify the recipient digital signature 170 using the recipient public verification key 176 and display the mutual verification result 178.

The alternative implementations 1200 show that the identity verification techniques described herein can operate at different layers of a communication ecosystem. An application may implement the techniques, an operating system may implement the techniques through the operating system telephony framework 1206, a carrier may implement the techniques through the carrier verification system 1208, or an enterprise or government system may implement the techniques through a managed communication system. In each implementation, the caller computing device 102 may produce the digital signature 142 over the per call challenge 140 using the device bound private signing key 124, and the recipient computing device 104 may use the public verification key 136 to generate the verification result 146 associated with the voice call.

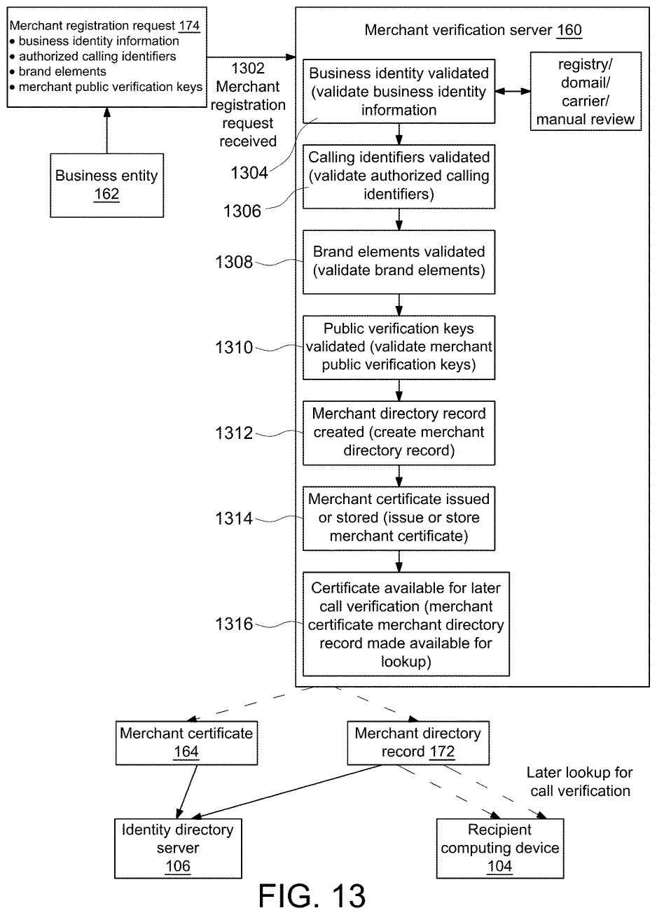

FIG. 13 illustrates an example verified merchant certificate issuance process 1300, according to one or more embodiments of the present invention. The verified merchant certificate issuance process 1300 may operate separately from the individual user registration process 200 described with respect to FIG. 2. In an individual user registration process, the identity directory server 106 may associate the public verification key 136 with the identity 138 of an individual user. In the verified merchant certificate issuance process 1300, a merchant verification server 160 verifies a business entity 162 and issues or stores a merchant certificate 164 that associates the business entity 162 with one or more authorized calling identifiers 166, one or more brand elements 168, and one or more merchant public verification keys 170.

In some embodiments, the merchant verification server 160 forms part of the identity directory server 106. In other embodiments, the merchant verification server 160 communicates with the identity directory server 106 and stores merchant certificate information in a merchant directory record 172. The merchant verification server 160 may include one or more servers, databases, certificate services, administrative review systems, or identity verification systems that verify the business entity 162 before the system permits display of a verified business call indication at the recipient computing device 104.

At step 1302, the merchant verification server 160 receives a merchant registration request 174 from the business entity 162 or from an authorized representative of the business entity 162. The merchant registration request 174 may include business identity information 176, the one or more authorized calling identifiers 166, the one or more brand elements 168, and the one or more merchant public verification keys 170. The business identity information 176 may include a legal business name, a trade name, a doing business as name, a business category, a corporate registration number, a tax identifier, a registered address, a website domain, an email domain, an enterprise identity provider identifier, a merchant account identifier, or another identifier associated with the business entity 162.

The one or more authorized calling identifiers 166 may include one or more telephone numbers, enterprise extensions, call center numbers, branch numbers, department numbers, SIP addresses, VoIP identifiers, carrier identifiers, account identifiers, or other calling identifiers that the business entity 162 uses to originate voice calls. The one or more brand elements 168 may include a logo, icon, brand name, department name, branch name, business category, call reason label, customer service label, verified merchant badge, brand color, website address, or other displayable information associated with the business entity 162. The one or more merchant public verification keys 170 correspond to one or more device bound private signing keys held by a caller computing device 102, an enterprise calling device, a call center terminal, an agent device, an enterprise hardware security module, or another caller computing system associated with the business entity 162.

At step 1304, the merchant verification server 160 verifies the business identity information 176. For example, the merchant verification server 160 may verify the business entity 162 using a corporate registry record, a tax record, a domain control record, an email domain record, a website record, a bank account record, a payment processor record, a carrier record, an enterprise identity provider record, a government record, a trademark record, a manual review result, a third party business verification result, or a combination thereof. In some embodiments, the merchant verification server 160 assigns an assurance level to the business entity 162 based on the number, type, or reliability of verification checks completed for the business entity 162.

At step 1306, the merchant verification server 160 validates the one or more authorized calling identifiers 166. In one example, the merchant verification server 160 confirms that the business entity 162 controls a telephone number by sending a code to the telephone number, checking a carrier record, checking a business account record, checking a service provider record, or receiving an authorization assertion from a carrier or enterprise communication provider. In another example, the merchant verification server 160 confirms that an enterprise identity provider authorizes a call center terminal, agent device, department number, or enterprise extension to originate calls for the business entity 162.

At step 1308, the merchant verification server 160 validates the one or more brand elements 168. In some embodiments, the merchant verification server 160 confirms that a submitted logo, business name, trade name, department name, website, or other brand element corresponds to the verified business identity information 176. In some embodiments, the merchant verification server 160 compares the one or more brand elements 168 against a trademark record, corporate registry record, verified website, enterprise account, manual review result, fraud list, or impersonation risk rule. The merchant verification server 160 may reject the merchant registration request 174 when a brand element appears to impersonate another entity, conflicts with the business identity information 176, or fails a merchant verification policy.

At step 1310, the merchant verification server 160 validates the one or more merchant public verification keys 170. In some embodiments, the merchant verification server 160 receives device attestation data, hardware attestation data, enterprise device management data, certificate data, key algorithm data, or other key status data associated with the one or more merchant public verification keys 170. The merchant verification server 160 may confirm that each merchant public verification key 170 corresponds to a device bound private signing key protected by a secure enclave, hardware security module, trusted execution environment, hardware backed keystore, StrongBox keystore, secure element, trusted platform module, enterprise hardware security module, or another secure storage component that prevents export of plaintext private key material.

At step 1312, the merchant verification server 160 creates the merchant directory record 172. The merchant directory record 172 associates the business entity 162 with the business identity information 176, the one or more authorized calling identifiers 166, the one or more brand elements 168, and the one or more merchant public verification keys 170. The merchant directory record 172 may also include a merchant account identifier, certificate identifier, issuer identifier, validity period, revocation status, assurance level, business category, authorized department, authorized agent, authorized device, brand element reference, certificate policy identifier, or other merchant verification information.

At step 1314, the merchant verification server 160 issues or stores the merchant certificate 164. The merchant certificate 164 binds the business identity information 176, the one or more authorized calling identifiers 166, the one or more brand elements 168, and the one or more merchant public verification keys 170 to the business entity 162. In some embodiments, the merchant certificate 164 includes the one or more brand elements 168. In other embodiments, the merchant certificate 164 includes a pointer, hash, digest, uniform resource locator, content address, or directory record identifier that references the one or more brand elements 168 stored in the merchant directory record 172 or in another trusted repository.

In some embodiments, the merchant verification server 160 signs the merchant certificate 164 using a certificate issuer key. In other embodiments, a certificate authority, carrier certificate authority, enterprise certificate authority, identity directory server 106, or other trusted issuer signs the merchant certificate 164. The merchant certificate 164 may include a certificate signature that allows the recipient computing device 104 to validate the merchant certificate 164 before the recipient computing device 104 displays a verified business call indication.

At step 1316, the merchant verification server 160 makes the merchant certificate 164, the merchant directory record 172, or both available for later call verification. For example, the merchant verification server 160 may store the merchant certificate 164 in the identity directory server 106, transmit the merchant certificate 164 to an enterprise calling system associated with the business entity 162, provide a merchant certificate identifier to the caller computing device 102, or provide access to the merchant certificate 164 through a directory lookup service. The recipient computing device 104 may later obtain the merchant certificate 164 or the merchant certificate identifier when the recipient computing device 104 receives the verification payload 144 associated with a particular instance of a voice call.

During a later verified business call, the caller computing device 102 or an enterprise calling system associated with the business entity 162 generates a per call challenge and produces a digital signature over the per call challenge using a device bound private signing key corresponding to one of the merchant public verification keys 170. The verification payload 144 may include the per call challenge, the digital signature, a merchant certificate identifier, the merchant certificate 164, a public key identifier, a calling identifier, a call reason, a department identifier, or a combination thereof. The recipient computing device 104 may obtain the merchant certificate 164 from the identity directory server 106 or from a local cache.

The recipient computing device 104 may validate the merchant certificate 164 by verifying a certificate signature, checking a validity period, checking revocation status, confirming that the merchant certificate 164 authorizes a calling identifier associated with the voice call, confirming that the merchant certificate 164 authorizes the public verification key used to verify the digital signature, and confirming that the one or more brand elements 168 correspond to the merchant certificate 164 or to the merchant directory record 172. When the recipient computing device 104 determines that the digital signature and the merchant certificate 164 are valid, the recipient computing device 104 may display a verified business call indication before the voice call is answered.

The verified business call indication may include a business name, logo, department name, branch name, call reason, verified merchant badge, assurance level, or certificate status. In one example, the recipient computing device 104 displays “Bank of America,” a corresponding logo, a fraud prevention department label, and a verified merchant badge before the recipient answers the voice call. In another example, the recipient computing device 104 displays a hospital name, an appointment reminder label, and a verified business call indication before the recipient answers the voice call. In another example, the recipient computing device 104 displays a delivery company name, a local branch identifier, and a verified merchant badge before the recipient answers the voice call.

In some embodiments, the recipient computing device 104 applies different user interface treatments to verified business callers and verified individual callers. For example, the recipient computing device 104 may display a verified individual caller with a personal name, contact image, and verified person badge when the verification payload 144 corresponds to an individual registration record. The recipient computing device 104 may display a verified business caller with a business name, logo, department name, call reason, verified merchant badge, and assurance level when the verification payload 144 corresponds to the merchant certificate 164. The recipient computing device 104 may display the verified business call indication on a native incoming call screen, a notification overlay, a lock screen notification, an application call screen, a carrier controlled call display, a wearable device interface, a vehicle communication interface, a desktop interface, or an enterprise communication interface.

In some embodiments, the recipient computing device 104 suppresses display of the one or more brand elements 168 when the merchant certificate 164 has expired, has been revoked, does not authorize the calling identifier, does not authorize the public verification key, or fails validation. In such embodiments, the recipient computing device 104 may display a generic caller identity, an individual verified caller indication, a reduced assurance indication, or a verification failure warning. In some embodiments, the recipient computing device 104 displays a warning that the business identity could not be cryptographically verified.

In some embodiments, the merchant verification server 160 revokes, suspends, renews, reissues, or updates the merchant certificate 164. For example, the merchant verification server 160 may revoke the merchant certificate 164 when the business entity 162 no longer controls an authorized calling identifier, when a device bound private signing key associated with a merchant public verification key 170 becomes compromised or replaced, when a brand element changes, when a merchant account terminates, or when the merchant verification server 160 detects fraud or impersonation. The merchant verification server 160 may issue a replacement merchant certificate that binds a replacement merchant public verification key to the business entity 162.

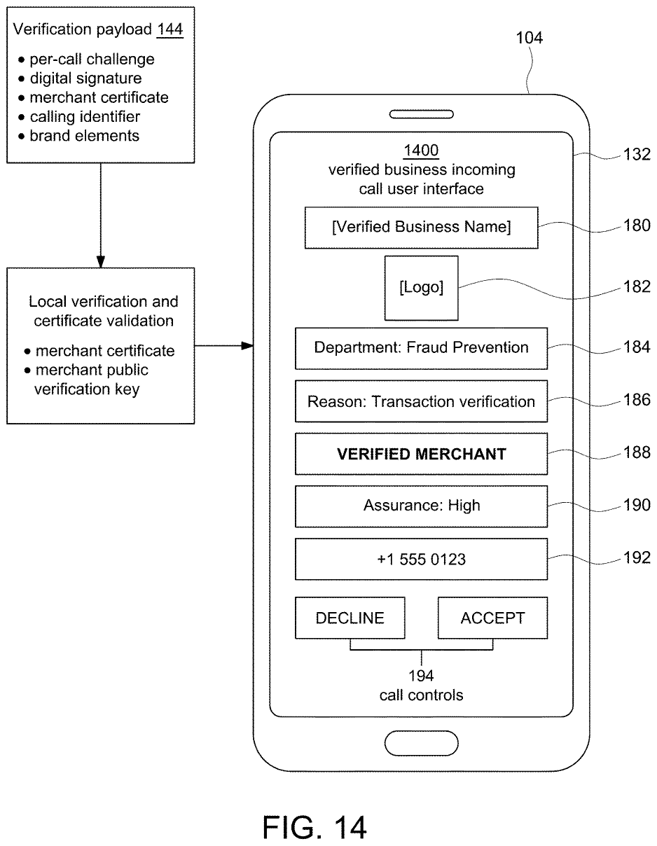

FIG. 14 illustrates an example verified business incoming call user interface 1400, according to one or more embodiments of the present invention. The verified business incoming call user interface 1400 may be displayed by the recipient computing device 104 before a recipient answers a voice call associated with the business entity 162. The verified business incoming call user interface 1400 may operate with the merchant certificate 164 described with respect to FIG. 13 and may allow the recipient computing device 104 to distinguish a verified business caller from a verified individual caller before the recipient answers the voice call.

In some embodiments, the verified business incoming call user interface 1400 appears on a recipient display 132 of the recipient computing device 104. The verified business incoming call user interface 1400 may appear within a native incoming call screen, an application call screen, a notification overlay, a lock screen notification, a carrier controlled call display, an enterprise communication interface, a wearable device interface, a vehicle communication interface, a desktop communication interface, or another call presentation interface. In some embodiments, an operating system of the recipient computing device 104 displays at least part of the verified business incoming call user interface 1400. In other embodiments, an application executing on the recipient computing device 104 displays at least part of the verified business incoming call user interface 1400.

In the illustrated embodiment, the verified business incoming call user interface 1400 includes a business name field 180, a logo field 182, a department field 184, a call reason field 186, a verified merchant badge 188, and a certificate assurance indication 190. The business name field 180 may display a legal business name, trade name, doing business as name, brand name, or other business name associated with the business entity 162. The logo field 182 may display a logo, icon, brand mark, or other brand element included in or referenced by the one or more brand elements 168. The department field 184 may display a department, branch, business unit, agent group, support group, fraud prevention group, billing group, appointment group, or other subdivision associated with the business entity 162. The call reason field 186 may display a reason for the voice call, such as fraud alert, appointment reminder, prescription update, delivery update, account support, billing support, customer service, transaction verification, or another call reason.

The verified merchant badge 188 may indicate that the recipient computing device 104 has validated the merchant certificate 164 and has locally verified a digital signature associated with the particular instance of the voice call. The certificate assurance indication 190 may indicate an assurance level associated with the merchant certificate 164, the business entity 162, the calling identifier, the merchant public verification key 170, or a combination thereof. For example, the certificate assurance indication 190 may display a text label, icon, badge, numerical level, color treatment, haptic output, audible output, or other indication that corresponds to a level of verification completed for the business entity 162.

In some embodiments, the verified business incoming call user interface 1400 also includes a calling identifier field 192. The calling identifier field 192 may display a telephone number, enterprise extension, call center number, branch number, SIP address, VoIP identifier, carrier identifier, account identifier, or other calling identifier associated with the voice call. The calling identifier field 192 may correspond to one of the one or more authorized calling identifiers 166 bound to the business entity 162 by the merchant certificate 164.

In some embodiments, the verified business incoming call user interface 1400 also includes one or more call controls 194. The one or more call controls 194 may include an accept control, decline control, silence control, message control, report control, block control, callback control, information control, or another call control. The recipient computing device 104 may display the verified business incoming call user interface 1400 before the recipient selects an accept control from the one or more call controls 194.

Before displaying the verified business incoming call user interface 1400 with the verified merchant badge 188, the recipient computing device 104 may receive the verification payload 144 associated with the particular instance of the voice call. The verification payload 144 may include a per call challenge, a digital signature, a public key identifier, a merchant certificate identifier, the merchant certificate 164, one of the one or more authorized calling identifiers 166, call context information, or a combination thereof. The call context information may include a department identifier, call reason, ticket identifier, appointment identifier, transaction identifier, customer support category, branch identifier, agent identifier, or other information associated with the voice call.

The recipient computing device 104 may obtain the merchant certificate 164 from the verification payload 144, the identity directory server 106, the merchant verification server 160, the merchant directory record 172, a local cache, or another trusted source. The recipient computing device 104 may obtain one of the one or more merchant public verification keys 170 from the merchant certificate 164, the identity directory server 106, the merchant verification server 160, the merchant directory record 172, a local cache, or another trusted source.

The recipient computing device 104 validates the merchant certificate 164 before the recipient computing device 104 displays the verified merchant badge 188. In some embodiments, the recipient computing device 104 validates the merchant certificate 164 by verifying a certificate signature, checking a validity period, checking revocation status, checking a certificate policy identifier, checking an issuer identifier, confirming that the merchant certificate 164 authorizes the calling identifier associated with the voice call, confirming that the merchant certificate 164 authorizes the merchant public verification key 170 used to verify the digital signature, and confirming that the one or more brand elements 168 correspond to the merchant certificate 164 or to the merchant directory record 172.

The recipient computing device 104 locally verifies the digital signature using the merchant public verification key 170. In some embodiments, the recipient computing device 104 generates a verification result locally and does not receive the verification result from the merchant verification server 160, the identity directory server 106, the verification routing server 108, or another server. The recipient computing device 104 may display the verified merchant badge 188 only when the recipient computing device 104 determines that the digital signature is valid and that the merchant certificate 164 authorizes the business name field 180, the logo field 182, the calling identifier field 192, and the merchant public verification key 170.

In some embodiments, the recipient computing device 104 displays the business name field 180, the logo field 182, the department field 184, the call reason field 186, the verified merchant badge 188, and the certificate assurance indication 190 before the voice call is answered. In some embodiments, the recipient computing device 104 displays the verified business incoming call user interface 1400 during a ringing interval, call setup interval, incoming call notification interval, lock screen notification interval, or other interval before the recipient accepts the voice call. In some embodiments, the recipient computing device 104 continues to display at least part of the verified business incoming call user interface 1400 during the voice call.

In one example, the business name field 180 displays “Bank of America,” the logo field 182 displays a corresponding logo, the department field 184 displays “Fraud Prevention,” the call reason field 186 displays “Transaction verification,” the verified merchant badge 188 displays a verified business indication, and the certificate assurance indication 190 displays a high assurance level before the recipient answers the voice call. In another example, the business name field 180 displays a hospital name, the department field 184 displays “Appointments,” and the call reason field 186 displays “Appointment reminder.” In another example, the business name field 180 displays a delivery company name, the department field 184 displays a local branch identifier, and the call reason field 186 displays “Delivery update.”

In some embodiments, the recipient computing device 104 displays different user interface elements for a verified business caller and a verified individual caller. For a verified individual caller, the recipient computing device 104 may display a personal name, contact image, telephone number, verified person badge, or device verified identity indication. For a verified business caller, the recipient computing device 104 may display the business name field 180, the logo field 182, the department field 184, the call reason field 186, the verified merchant badge 188, and the certificate assurance indication 190. The recipient computing device 104 may select the business user interface when the verification payload 144 includes the merchant certificate 164 or a merchant certificate identifier and may select the individual user interface when the verification payload 144 corresponds to an individual registration record without the merchant certificate 164.

In some embodiments, the recipient computing device 104 changes the verified business incoming call user interface 1400 based on a certificate status. For example, when the merchant certificate 164 is valid, the recipient computing device 104 may display the verified merchant badge 188 and the one or more brand elements 168. When the merchant certificate 164 has expired, has been revoked, does not authorize the calling identifier, does not authorize the merchant public verification key 170, or fails validation, the recipient computing device 104 may suppress the logo field 182, suppress the verified merchant badge 188, display a generic caller identity, display a reduced assurance indication, display an unverified business indication, or display a verification failure warning.

In some embodiments, the recipient computing device 104 displays the verified business incoming call user interface 1400 using cached data. For example, the recipient computing device 104 may cache the merchant certificate 164, one or more brand elements 168, the merchant public verification key 170, or the merchant directory record 172. The recipient computing device 104 may use the cached data when the cached data remains within a validity period and when the recipient computing device 104 has not received revocation information for the merchant certificate 164. In some embodiments, the recipient computing device 104 displays the certificate assurance indication 190 with a reduced assurance level when the recipient computing device 104 uses cached data and cannot check revocation status in real time.

In some embodiments, the verified business incoming call user interface 1400 includes an information control that allows the recipient to view additional merchant certificate information. The additional merchant certificate information may include the legal business name, certificate issuer, certificate validity period, assurance level, authorized calling identifier, department name, website, verified domain, or certificate status. In some embodiments, the recipient computing device 104 allows the recipient to report a suspicious call, block future calls from the calling identifier, or request additional identity details when the merchant certificate 164 fails validation.

The verified business incoming call user interface 1400 therefore allows the recipient computing device 104 to present business identity information before the recipient answers the voice call while preserving the device based cryptographic verification described herein. The recipient computing device 104 displays the business name field 180, the logo field 182, the department field 184, the call reason field 186, the verified merchant badge 188, or the certificate assurance indication 190 based on local verification of the digital signature and validation of the merchant certificate 164 rather than based solely on caller identification information supplied through a voice transport channel.

The invention provides cryptographic verification of an identity associated with a voice call before the voice call is answered. Because the caller computing device produces the digital signature over the per call challenge using the device bound private signing key, the recipient computing device can evaluate proof associated with a particular call instance rather than relying only on caller identification information, voice recognition, call reputation data, or network level attestation. The verification data channel operates separately from the voice transport channel, which allows the invention to work with cellular calls, public switched telephone network calls, Voice over Internet Protocol calls, satellite calls, enterprise calls, native telephony calls, and other voice communication systems. The recipient computing device can generate the verification result locally using the public verification key, thereby reducing dependence on a server to determine whether the caller identity is verified.

The invention also improves resistance to spoofing, replay, account compromise, subscriber identity module swap attacks, and voice cloning attacks. The per call challenge may include the call identifier, the timestamp, and the nonce, which helps bind the digital signature to the particular instance of the voice call and helps prevent reuse of a captured verification payload. The device bound private signing key may remain protected by the caller secure storage component, which reduces the risk that an attacker can copy private key material and impersonate the identity of the caller from another device. The invention further supports post quantum signature algorithms, classical public key signature algorithms, and hybrid signature schemes, allowing the system to adapt to different security requirements while preserving the same caller identity verification architecture.

Although particular embodiments of the invention have been described in detail for purposes of illustration, various modifications and enhancements may be made without departing from the spirit and scope of the invention.

What is claimed is:

1. A computer-implemented method for verifying an identity associated with a voice call, the method comprising:
generating, by a caller computing device, a per-call challenge associated with a particular instance of the voice call;
producing, by the caller computing device, a digital signature over the per-call challenge using a device-bound private signing key associated with the caller computing device;
initiating, by the caller computing device, the voice call to a recipient computing device over a voice transport channel;
transmitting, from the caller computing device to the recipient computing device, a verification payload over a verification data channel that is separate from the voice transport channel, the verification payload comprising the per-call challenge and the digital signature;
obtaining, by the recipient computing device, a public verification key associated with an identity of a caller of the voice call;
verifying, by the recipient computing device, the digital signature using the public verification key to generate a verification result, wherein the verifying is performed locally by the recipient computing device without receiving the verification result from a server; and
displaying, by the recipient computing device, an indication of the verification result before the voice call is answered at the recipient computing device.

2. The method of claim 1, wherein the device-bound private signing key is generated within, stored within, wrapped by, or otherwise protected by a hardware-backed secure storage component of the caller computing device such that plaintext private-key material corresponding to the device-bound private signing key is not exportable from the caller computing device.

3. The method of claim 1, wherein producing the digital signature comprises using an asymmetric digital signature algorithm selected from a post-quantum digital signature algorithm, a classical public-key digital signature algorithm, or a hybrid signature scheme comprising both a post-quantum digital signature and a classical public-key digital signature.

4. The method of claim 3, wherein the asymmetric digital signature algorithm comprises at least one of ML-DSA, SLH-DSA, Falcon, ECDSA, EdDSA, or RSA-PSS.

5. The method of claim 1, wherein the per-call challenge comprises a call identifier, a timestamp, and a nonce, and wherein the recipient computing device rejects the verification payload when the timestamp is outside a predetermined recency window.

6. The method of claim 1, wherein the voice transport channel comprises a cellular voice channel, a public switched telephone network channel, a Voice over Internet Protocol channel, a satellite voice channel, or a native telephony channel of a mobile operating system.

7. The method of claim 1, wherein the verification data channel comprises a push-notification channel, a messaging channel, a packet data channel, a signalling channel, a WebRTC data channel, a SIP signalling channel, an RCS channel, or a carrier signalling channel.

8. The method of claim 1, wherein the caller computing device initiates the voice call by invoking a native telephony function of an operating system of the caller computing device, and wherein audio content of the voice call is not carried by infrastructure that routes the verification payload.

9. The method of claim 1, further comprising requiring, by the caller computing device, successful local user authentication before producing the digital signature, wherein the successful local user authentication comprises biometric authentication, passcode authentication, device-unlock authentication, possession of the caller computing device, or a combination thereof.

10. The method of claim 1, further comprising transmitting, from the recipient computing device to the caller computing device, a recipient verification payload comprising a recipient per-call challenge or a signed response, and locally verifying, by the caller computing device, the recipient verification payload to produce a mutual-verification result.

11. The method of claim 1, wherein the voice call comprises a Public Switched Telephone Network call, and wherein the verification payload is transmitted to the recipient computing device via a data channel separate from and parallel to a voice channel carrying the Public Switched Telephone Network call.

12. A system for verifying an identity associated with a voice call, the system comprising:
a caller computing device comprising one or more caller processors and a device-bound private signing key;
a recipient computing device comprising one or more recipient processors; and
an identity directory server configured to store a public verification key associated with an identity of a caller; wherein the caller computing device is configured to:
generate a per-call challenge associated with a particular instance of the voice call;
produce a digital signature over the per-call challenge using the device-bound private signing key;
initiate the voice call to the recipient computing device over a voice transport channel; and
transmit, to the recipient computing device, a verification payload over a verification data channel that is separate from the voice transport channel, the verification payload comprising the per-call challenge and the digital signature; and
wherein the recipient computing device is configured to:
obtain the public verification key associated with the identity of the caller;
verify the digital signature using the public verification key to generate a verification result, wherein the verification result is generated locally by the recipient computing device without the identity directory server determining the verification result; and
display an indication of the verification result before the voice call is answered at the recipient computing device.

13. The system of claim 12, wherein the device-bound private signing key is protected by a secure hardware component comprising a secure enclave, a hardware security module, a trusted execution environment, a hardware-backed keystore, a secure element, or a trusted platform module.

14. The system of claim 12, wherein the public verification key is associated in the identity directory server with at least one identity anchor selected from a telephone number, a subscriber identity module identifier, a device identifier, an operating-system identity, an enterprise identity, a decentralized identifier, a carrier-issued identity, or a government-issued identity.

15. The system of claim 12, wherein the recipient computing device is further configured to store the public verification key as a pinned public verification key and to display a key-change warning when a subsequently obtained public verification key for the identity of the caller differs from the pinned public verification key.

16. The system of claim 12, wherein the identity directory server stores a plurality of public verification keys associated with the identity of the caller, and wherein the recipient computing device is configured to generate the verification result by determining whether the digital signature verifies against at least one public verification key of the plurality of public verification keys.

17. The system of claim 12, wherein the recipient computing device is further configured to generate the verification result based on both the digital signature and at least one additional authentication factor comprising biometric authentication, device-unlock status, subscriber identity module status, location consistency, device attestation, account authentication, or enterprise identity-provider authentication.

18. The system of claim 12, wherein the caller computing device is further configured to rotate the device-bound private signing key by generating a replacement public verification key and causing a key-transition record to be stored in the identity directory server, the key-transition record comprising the replacement public verification key signed using the device-bound private signing key.

19. The system of claim 12, wherein the voice call comprises a Public Switched Telephone Network call, and wherein the caller computing device is configured to transmit the verification payload to the recipient computing device via a data channel separate from and parallel to a voice channel carrying the Public Switched Telephone Network call.

20. A non-transitory computer-readable medium storing instructions that, when executed by one or more processors of a recipient computing device, cause the recipient computing device to perform operations comprising:
receiving, over a verification data channel, a verification payload associated with a voice call received over a voice transport channel that is separate from the verification data channel, the verification payload comprising a per-call challenge and a digital signature produced by a caller computing device using a device-bound private signing key;
obtaining a public verification key associated with an identity of a caller of the voice call;
verifying the digital signature using the public verification key to generate a verification result locally at the recipient computing device; and
displaying, before the voice call is answered at the recipient computing device, an indication that the identity of the caller is verified when the verification result indicates successful verification or an indication that the identity of the caller is not verified when the verification result indicates unsuccessful verification.

21. The non-transitory computer-readable medium of claim 20, wherein the operations further comprise determining whether the per-call challenge comprises a call identifier, a timestamp, and a nonce, and rejecting the verification payload when the timestamp is outside a predetermined recency window.

22. The non-transitory computer-readable medium of claim 20, wherein the operations further comprise displaying the indication as an overlay, notification, banner, badge, icon, warning, or native call-interface element on or adjacent to a native incoming-call interface of the recipient computing device.

23. The non-transitory computer-readable medium of claim 20, wherein the voice call comprises a Public Switched Telephone Network call, and wherein the verification payload is received via a data channel separate from and parallel to a voice channel carrying the Public Switched Telephone Network call.

24. A method for mutual cryptographic verification of participants in a voice call, the method comprising:
generating, by a first computing device, a first per-call challenge associated with a particular instance of a voice call;
producing, by the first computing device, a first digital signature over the first per-call challenge using a first device-bound private signing key associated with the first computing device, wherein plaintext private key material corresponding to the first device-bound private signing key is not exported from a secure storage component of the first computing device;
transmitting, from the first computing device to a second computing device, a first verification payload comprising the first per-call challenge and the first digital signature;
obtaining, by the second computing device, a first public verification key associated with an identity of a user of the first computing device;
locally verifying, by the second computing device, the first digital signature using the first public verification key to generate a first verification result without receiving the first verification result from a server;
generating, by the second computing device, a second per-call challenge or signed response associated with the particular instance of the voice call;
producing, by the second computing device, a second digital signature using a second device-bound private signing key associated with the second computing device, wherein plaintext private key material corresponding to the second device-bound private signing key is not exported from a secure storage component of the second computing device;
transmitting, from the second computing device to the first computing device, a second verification payload comprising the second per-call challenge or signed response and the second digital signature;
obtaining, by the first computing device, a second public verification key associated with an identity of a user of the second computing device;
locally verifying, by the first computing device, the second digital signature using the second public verification key to generate a second verification result without receiving the second verification result from a server; and
displaying, by the first computing device and the second computing device, respective indications of the first verification result and the second verification result.

25. The method of claim 24, wherein the secure storage component of the first computing device or the secure storage component of the second computing device comprises a secure enclave, a hardware security module, a trusted execution environment, a hardware-backed keystore, a StrongBox keystore, a secure element, a trusted platform module, or a hardware-backed secure storage component configured to prevent export of plaintext private key material.

26. The method of claim 24, wherein the first digital signature or the second digital signature is produced using a post-quantum digital signature algorithm, a classical public-key digital signature algorithm, or a hybrid signature scheme comprising both a post-quantum digital signature and a classical public-key digital signature.

27. The method of claim 26, wherein the post-quantum digital signature algorithm comprises ML-DSA, SLH-DSA, Falcon, or another post-quantum digital signature algorithm, and wherein the classical public-key digital signature algorithm comprises ECDSA, EdDSA, RSA-PSS, or another classical public-key digital signature algorithm.

28. The method of claim 24, wherein the respective indications of the first verification result and the second verification result are displayed before the voice call is answered by the second computing device, before audio content of the voice call is exchanged between the first computing device and the second computing device, or during a call setup interval associated with the particular instance of the voice call.

29. The method of claim 24, wherein the first per-call challenge, the second per-call challenge, or both comprise a call identifier, a timestamp, and a nonce, and wherein locally verifying the first digital signature or locally verifying the second digital signature comprises rejecting a corresponding verification payload when the timestamp falls outside a predetermined recency window, when the nonce has previously been used, or when the call identifier does not correspond to the particular instance of the voice call.

30. The method of claim 24, wherein displaying the respective indications comprises displaying a verified indication, a verification failure indication, a warning, an icon, a badge, a banner, an overlay, a notification, a color-coded element, a sound, a haptic output, or a native call-interface element on or adjacent to a native incoming-call interface, a native outgoing-call interface, an application call interface, a carrier-controlled call interface, an enterprise communication interface, a wearable-device interface, a vehicle communication interface, or an operating-system telephony interface.

31. The method of claim 24, wherein the voice call comprises a Public Switched Telephone Network call, and wherein the first verification payload, the second verification payload, or both are transmitted via a data channel separate from and parallel to a voice channel carrying the Public Switched Telephone Network call.

32. A system for mutual cryptographic verification of participants in a voice call, the system comprising:
a first computing device comprising one or more first processors, first memory, a first communication interface, a first display, and a first secure storage component configured to protect a first device-bound private signing key;
a second computing device comprising one or more second processors, second memory, a second communication interface, a second display, and a second secure storage component configured to protect a second device-bound private signing key; and
an identity directory server configured to store a first public verification key associated with an identity of a user of the first computing device and a second public verification key associated with an identity of a user of the second computing device;
wherein the first computing device is configured to:
generate a first per-call challenge associated with a particular instance of a voice call;
produce a first digital signature over the first per-call challenge using the first device-bound private signing key, wherein plaintext private key material corresponding to the first device-bound private signing key is not exported from the first secure storage component; and
transmit, to the second computing device, a first verification payload comprising the first per-call challenge and the first digital signature;
wherein the second computing device is configured to:
obtain the first public verification key associated with the identity of the user of the first computing device;
locally verify the first digital signature using the first public verification key to generate a first verification result without receiving the first verification result from a server;
generate a second per-call challenge or signed response associated with the particular instance of the voice call;
produce a second digital signature using the second device-bound private signing key, wherein plaintext private key material corresponding to the second device-bound private signing key is not exported from the second secure storage component;
and transmit, to the first computing device, a second verification payload comprising the second per-call challenge or signed response and the second digital signature;
wherein the first computing device is further configured to:
obtain the second public verification key associated with the identity of the user of the second computing device; and
locally verify the second digital signature using the second public verification key to generate a second verification result without receiving the second verification result from a server; and
wherein the first computing device and the second computing device are configured to display respective indications of the first verification result and the second verification result.

33. A non-transitory computer-readable medium storing instructions that, when executed by one or more processors of one or more computing devices, cause the one or more computing devices to perform operations for mutual cryptographic verification of participants to a voice call, the operations comprising:
generating, by a first computing device, a first per-call challenge associated with a particular instance of a voice call;
producing, by the first computing device, a first digital signature over the first per-call challenge using a first device-bound private signing key associated with the first computing device, wherein plaintext private key material corresponding to the first device-bound private signing key is not exported from a secure storage component of the first computing device;
transmitting, from the first computing device to a second computing device, a first verification payload comprising the first per-call challenge and the first digital signature;
obtaining, by the second computing device, a first public verification key associated with an identity of a user of the first computing device;
locally verifying, by the second computing device, the first digital signature using the first public verification key to generate a first verification result without receiving the first verification result from a server;
generating, by the second computing device, a second per-call challenge or signed response associated with the particular instance of the voice call;
producing, by the second computing device, a second digital signature using a second device-bound private signing key associated with the second computing device, wherein plaintext private key material corresponding to the second device-bound private signing key is not exported from a secure storage component of the second computing device;
transmitting, from the second computing device to the first computing device, a second verification payload comprising the second per-call challenge or signed response and the second digital signature;
obtaining, by the first computing device, a second public verification key associated with an identity of a user of the second computing device;
locally verifying, by the first computing device, the second digital signature using the second public verification key to generate a second verification result without receiving the second verification result from a server; and
displaying, by the first computing device and the second computing device, respective indications of the first verification result and the second verification result.

34. A method for verified business caller display associated with a voice call, the method comprising:
receiving, by one or more servers, a merchant registration request associated with a business entity, the merchant registration request comprising business identity information, at least one brand element, at least one calling identifier, and at least one public verification key associated with a device-bound private signing key;
verifying, by the one or more servers, that the business entity is associated with the business identity information and is authorized to use the at least one calling identifier and the at least one brand element;
issuing or storing, by the one or more servers, a merchant certificate that binds the business identity information, the at least one calling identifier, the at least one brand element, and the at least one public verification key to the business entity;
receiving, by a recipient computing device, a verification payload associated with a particular instance of a voice call, the verification payload comprising a per-call challenge, a digital signature produced over the per-call challenge using the device-bound private signing key, and merchant certificate information corresponding to the merchant certificate;
obtaining, by the recipient computing device, the at least one public verification key associated with the merchant certificate;
locally verifying, by the recipient computing device, the digital signature using the at least one public verification key;
validating, by the recipient computing device, the merchant certificate information by determining that the merchant certificate authorizes at least one of the calling identifier, the at least one brand element, or the at least one public verification key; and
displaying, by the recipient computing device before the voice call is answered, a verified business call indication comprising at least one of a business name, a logo, a department name, a call reason, a verified merchant badge, or an assurance level.

35. The method of claim 34, wherein the at least one brand element comprises a logo, icon, trademark, service mark, brand color, verified business badge, department label, business category, call reason, or customer-support category.

36. The method of claim 34, wherein verifying that the business entity is associated with the business identity information comprises validating at least one of a corporate registry record, tax record, domain-control record, email-domain record, website record, bank-account record, payment-processor record, carrier record, enterprise identity provider record, government record, trademark record, manual review result, or third-party business-verification result.

37. The method of claim 34, wherein the merchant certificate comprises a certificate identifier, issuer identifier, subject business identifier, validity period, revocation status, assurance level, business category, authorized telephone number, authorized calling device, authorized department, authorized agent, brand element reference, or certificate policy identifier.

38. The method of claim 34, wherein the at least one brand element is stored in the merchant certificate or is stored in a directory record referenced by the merchant certificate using a pointer, hash, digest, uniform resource locator, content-addressed identifier, or directory record identifier.

39. The method of claim 34, wherein validating the merchant certificate information comprises checking a certificate signature, checking a validity period, checking revocation status, confirming that the merchant certificate authorizes a calling telephone number associated with the voice call, and confirming that the merchant certificate authorizes the public verification key used to verify the digital signature.

40. The method of claim 34, wherein the recipient computing device suppresses display of the at least one brand element, displays a verification failure warning, or displays a generic caller identity when the merchant certificate is expired, revoked, inconsistent with the calling identifier, inconsistent with the public verification key, or otherwise invalid.

41. The method of claim 34, wherein the verified business call indication is displayed differently from an individual verified caller indication, and wherein the verified business call indication comprises a business name and logo while the individual verified caller indication comprises a personal name, contact photo, or verified person badge.

42. The method of claim 34, wherein the verified business call indication is displayed on or adjacent to a native incoming-call screen, notification overlay, lock-screen notification, application call screen, carrier-controlled call display, wearable-device interface, vehicle communication interface, desktop interface, or enterprise communication interface.

43. The method of claim 34, wherein the verification payload further comprises a call reason, department identifier, ticket identifier, appointment identifier, transaction identifier, customer-support category, or branch identifier.

44. The method of claim 34, wherein the device-bound private signing key is protected by a secure enclave, hardware security module, trusted execution environment, hardware-backed keystore, StrongBox keystore, secure element, trusted platform module, or hardware-backed secure storage component configured to prevent export of plaintext private key material.

45. The method of claim 34, wherein the digital signature is produced using a post-quantum digital signature algorithm, a classical public-key digital signature algorithm, or a hybrid signature scheme comprising both a post-quantum digital signature and a classical public-key digital signature.

46. The method of claim 34, further comprising caching, by the recipient computing device, the merchant certificate or the at least one brand element, and using the cached merchant certificate or cached brand element to display the verified business call indication when the cached merchant certificate or cached brand element remains within a validity period.

47. The method of claim 34, further comprising revoking, suspending, expiring, renewing, reissuing, or updating the merchant certificate in response to a change in business identity information, loss of control of an authorized calling identifier, compromise or replacement of a device-bound private signing key, change in a brand element, merchant account termination, or detection of fraud or impersonation.

48. A system for verified business caller display associated with a voice call, the system comprising:
one or more merchant verification servers configured to receive a merchant registration request associated with a business entity, verify business identity information associated with the business entity, verify authorization to use at least one calling identifier and at least one brand element, and issue or store a merchant certificate that binds the business identity information, the at least one calling identifier, the at least one brand element, and at least one public verification key to the business entity;
a caller computing system associated with the business entity, the caller computing system comprising a secure storage component configured to protect a device-bound private signing key corresponding to the at least one public verification key, the caller computing system being configured to generate a per-call challenge associated with a particular instance of a voice call and produce a digital signature over the per-call challenge using the device-bound private signing key; and
a recipient computing device configured to receive a verification payload associated with the particular instance of the voice call, the verification payload comprising the per-call challenge, the digital signature, and merchant certificate information corresponding to the merchant certificate;
wherein the recipient computing device is further configured to:
obtain the at least one public verification key associated with the merchant certificate;
locally verify the digital signature using the at least one public verification key;
validate the merchant certificate information by determining that the merchant certificate authorizes at least one of the calling identifier, the at least one brand element, or the at least one public verification key; and
display, before the voice call is answered, a verified business call indication comprising at least one of a business name, a logo, a department name, a call reason, a verified merchant badge, or an assurance level.

49. A non-transitory computer-readable medium storing instructions that, when executed by one or more processors of a recipient computing device, cause the recipient computing device to perform operations comprising:
receiving a verification payload associated with a particular instance of a voice call, the verification payload comprising a per-call challenge, a digital signature produced over the per-call challenge using a device-bound private signing key associated with a business caller, and merchant certificate information corresponding to a merchant certificate;
obtaining a public verification key associated with the merchant certificate;
locally verifying the digital signature using the public verification key;
validating the merchant certificate information by determining that the merchant certificate authorizes at least one of a calling identifier, a brand element, or the public verification key;
determining whether the voice call is associated with a verified business caller or a verified individual caller; and
displaying, before the voice call is answered, a verified business call indication when the voice call is associated with the verified business caller, the verified business call indication comprising at least one of a business name, a logo, a department name, a call reason, a verified merchant badge, or an assurance level.
